(19) United States
(12) Patent Application Publication
(10) Pub. No.: US 2016/0083119 A1
(43) Pub. Date: Mar. 24, 2016

(54) Thrust Augmentation Systems

(71) Applicant: Craig Davidson, Albuquerque, NM (US)

(72) Inventor: Craig Davidson, Albuquerque, NM (US)

(21) Appl. No.: 14/703,748

(22) Filed: May 4, 2015

Related U.S. Application Data
(60) Provisional application No. 61/987,973, filed on May 2, 2014.
(60) Provisional application No. 62/002,544, filed on May 23, 2014.

(51) Int. Cl. B64G 1/40

(52) U.S. Cl. CPC B64G 1/405

(57) ABSTRACT

Methods and apparatuses for augmenting thrusts using ionized gases. A gas is partially ionized, which then ionizes a second, neutral gas. Vector addition can be used to increase the velocity of the first ionized gas with relatively high efficiency due to the gyroradii of the ionized particles. If the velocity is sufficiently high the critical ionization velocity of at least some of the elements in the second gas will be exceeded, greatly increasing A magnetic field creates a Townsend cascade in the ionized gases, greatly increasing the amount of ionized gases. The magnetic field can be created using permanent magnets or superconductors, thereby requiring little or no power to operate. To produce thrust the ionized gases are accelerated through a coil, which can have logarithmically increasing coil spacings. Electrical power can be generated by passing the accelerated ionized gas through generating coils and/or a turbine. In another embodiment, electromagnetic forces in the atmosphere can be used to propel a vehicle that has parallel superconducting coils circumferentially disposed about an axis of travel of the vehicle, the coils comprising one or more moveable segments which are reversibly disconnectable from other segments in said coil, thereby allowing the polarity of the coil to be reversed. The ionization engines described above can be used to further accelerate or decelerate the vehicle.

### CROSS-REFERENCE TO RELATED APPLICATIONS

This application claims priority to and the benefit of the filing of U.S. Provisional Patent Application Ser. No. 61/987,973, entitled “Thrust Augmentation Systems”, filed on May 2, 2014, and U.S. Provisional Patent Application Ser. No. 62/002,544, entitled “Thrust Augmentation Systems”, filed on May 23, 2014, and the specifications and claims thereof are incorporated herein by reference.

### BACKGROUND OF THE INVENTION

1. Field of the Invention (Technical Field)

The present invention is related to methods and apparatuses for creating and/or augmenting thrust, and the uses of that generated thrust.

2. Background Discussion

Note that the following discussion refers to a number of publications and references. Discussion of such publications herein is given for more complete background of the scientific principles and is not to be construed as an admission that such publications are prior art for patentability determination purposes.

The generation of thrust by the use of magnetic fields has been investigated for over half a century; see for example U.S. Pat. No. 2,997,436: “It has been determined that if a very rapidly changing high intensity magnetic field is impressed through a gas zone that the potentials generated in space cause ionization and produce a plasma. It has also been determined that if the magnetic lines of force define a field of generally conical or tapered configuration the plasma will be propelled toward the large end of the field. The reason for this is that the plasma is apparently initially pinched at the small end of the tapered magnetic field and as the pinch progresses toward the large end of the field the plasma is propelled outwardly.” U.S. Pat. No. 2,442,314 discloses a cascade method of ionization: “[ . . . ] it collides with molecules of the gas present and in so doing detaches electrons from atoms of the gas molecules, or in other words ionizes the molecules. These detached electrons, in a high field may in turn collide with other gas molecules and detach more electrons. The result of this chain-like sequence of events is to produce a large number of electrons which surge to the positively charged wire [ . . . ].” The Critical Ionization Velocity is the difference in speed between an ionized flow and neutral gases at which all of the neutral gas becomes ionized. A plasma torch, such as that disclosed in U.S. Pat. No. 5,200,595, can produce ionization. Superconducting coils and leads therefor are described in U.S. Pat. No. 4,544,979 and PCT Publication No. WO 2013114233 A1, and U.S. Pat. No. 5,361,055.

### SUMMARY OF THE INVENTION

### Disclosure of the Invention

The present invention is a method of generating thrust using an ionized gas, the method comprising ionizing a portion of a first gas; the ionized first gas ionizing a portion of a second gas in a magnetic field; and the magnetic field creating a Townsend cascade in the first and second ionized gases; and accelerating the ionized gas to create thrust. The magnetic field is preferably produced without requiring external power. The magnetic field is preferably produced by permanent magnets, electromagnets or superconductive electromagnetic coils, is preferably solenoid shaped, and preferably has a strength of greater than approximately one Tesla. The first gas is preferably ionized by a device selected from the group consisting of plasma torch, electric thruster, ionization pad, laser, solid rocket motor, chemical laser, and trigger diode. The second gas is optionally the same as the first gas, such as the unionized portion of the first gas. The method preferably further comprises increasing a velocity of the first ionized gas using vector addition, which is preferably generated by interactions of ionized gas particles via their gyroradii, preferably in a chamber comprising one or more high temperature paramagnetic materials. A difference between a velocity of the first gas and a velocity of the second gas preferably exceeds the Critical Ionization Velocity of at least one element in the second gas, so that preferably substantially every molecule of the element is ionized. The accelerating step preferably comprises passing the ionized gases pass through one or more coils comprising a logarithmically increasing spacing of adjacent coil segments after the step of creating a Townsend cascade. The coils preferably comprise a material selected from the group consisting of permanent magnetic, electromagnetic, or superconductive and can be arranged in series and/or in parallel. The ionized gases are preferably subsequently passed through an exhaust nozzle comprising a cone surrounded by a plurality of accelerator coils. At least one of the accelerator coils preferably comprises segments which can be selectively energized, thereby enabling control of directionality of an exhaust ion stream. The cone is also preferably surrounded by a plurality of generator coils which extract energy from the ionized gases. The method optionally comprises subsequently passing the ionized gases through a turbine to generate power.

The present invention is also a vehicle for traveling in an electromagnetic field of a celestial body, the vehicle comprising a plurality of parallel superconducting coils circumferentially disposed about an axis of travel of the vehicle, each coil comprising one or more moveable segments which are reversibly disconnectable from other segments in the coil. The polarity of each coil is preferably reversible when one of the moveable segments is disconnected from the coil. Each coil preferably comprises an aerogel jacket comprising a superconducting member surrounded by a cryogenic fluid. Solenoids preferably move the moveable segments, and seals prevent leakage of the cryogenic fluid. The vehicle optionally further comprises one or more engines for producing an electromagnetic field for accelerating or decelerating the vehicle.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate embodiments of the present invention and, together with the description, serve to explain the principles of the invention. The drawings are only for the purpose of illustrating certain embodiments of the invention and are not to be construed as limiting the invention. In the drawings:

FIG. 1 is a schematic diagram of methods of boost augmentation by stage.

FIG. 2 illustrates a simple electromagnetic/magnetic embodiment of the invention.

FIG. 3 illustrates a Blackjack embodiment of the invention utilizing secondary ionization or Townsend cascade.

FIG. 4 shows vector addition of thrust in a chemical/chemical embodiment of the present invention.

FIG. 5 is an example of second stage vector addition.

FIG. 6 is a schematic of a Blackjack vector addition ionization chamber.

FIG. 7 is a schematic of a commercial scale Blackjack vector addition ionization chamber.

FIG. 8 is a schematic of the exterior of the Blackjack chamber of FIG. 7.

FIG. 9 shows the importance of angle θ in a vector addition thrust chamber.

FIG. 10 shows the importance of critical ionization velocity.

FIG. 11 shows a logarithmic coil.

FIG. 12 is a schematic of a Blackjack ion thruster embodiment of the present invention.

FIG. 13 shows a Plasmoid exhaust nozzle.

FIG. 14 is a schematic of an embodiment of the Blackjack Shrike engine.

FIG. 15 shows a configuration of a commercial scale Blackjack cryostat.

FIG. 16 is a schematic of a commercial scale Blackjack engine.

FIG. 17 shows Laser Wakefield vector addition.

FIG. 18 is a schematic of a Blackjack Laser Wakefield engine.

FIG. 19 is a schematic of a Hammerhead rocket motor with a plasma torch.

FIG. 20 is a schematic of a Hammerhead Shrike rocket engine.

FIG. 21 is a schematic of a commercial scale Hammerhead rocket engine.

FIG. 22 is a schematic of a Longbow Shrike rocket engine.

FIG. 23 is a schematic of a commercial scale Longbow rocket engine.

FIG. 24 is a schematic of a Plasmoid Shrike rocket engine.

FIG. 25 is a schematic of a commercial scale Plasmoid rocket engine.

FIG. 26 is a schematic of a classic Plasmoid rocket engine.

FIG. 27 shows an embodiment of a third law drill of the present invention.

FIG. 28 is a schematic of a commercial scale Plasmoid power generator.

FIG. 29 is a schematic of a commercial scale Hammerhead power generator.

FIG. 30 is a schematic of a small scale Blackjack power generator.

FIG. 31 is a schematic of a commercial scale Blackjack power generator.

FIG. 32A shows an embodiment of a flat self-insulating superconductive cable of the present invention.

FIG. 32B shows an embodiment of a round self-insulating superconductive cable of the present invention.

FIG. 33 shows a Sharkfin primitive magnetic sail engine.

FIG. 34 shows field lines and the Birkeland Current of the Earth's magnetosphere.

FIG. 35 shows the Earth's magnetosphere and the sun's heliosphere.

FIG. 36 shows a physical persistent mode switch of the present invention.

FIG. 37 shows a polarity power switch of the present invention.

FIG. 38 shows a two segment reversible superconducting magnet.

FIG. 39 shows a four segment reversible superconducting magnet.

FIG. 40 shows a Sharkfin magnetic sail.

FIG. 41 is a representation of the Sharkfin deceleration mode.

FIG. 42 is a schematic of a variable thrust magnetic sail.

FIG. 43 is a schematic of a Sharkfin Shrike magnetic sail engine.

FIG. 44 is a schematic of a commercial scale Sharkfin magnetic sail engine.

FIG. 45 illustrates a method for calculating parabolic magnetic courses.

FIG. 46 shows an example of an optimal quadratic course diagram.

FIG. 47 is a photograph of an experimental setup demonstrating secondary ionization using permanent magnets.

### DETAILED DESCRIPTION OF EMBODIMENTS OF THE INVENTION

Embodiments of the present invention which use solid rocket motors as the bulk input are referred to as “Longbow” implementations. Embodiments of the invention which use liquid rocket motors as the bulk input are referred to as “Hammerhead” implementations. Embodiments of the invention which use liquid rocket motors and the specific fuel/oxidizer mixture of hydrogen and fluorine as the bulk input are referred to as “Plasmoid” implementations. Embodiments of the invention which use atmosphere or other gases as the bulk input are referred to as “Blackjack” implementations. Embodiments of the invention which use naturally occurring ionized fields as the bulk input are referred to as “Sharkfin” implementations. For each embodiment there may be several scales of implementation. A laser wakefield version uses the least amount of power to operate, and is the smallest type for a given embodiment. A “Shrike” version is the small scale version for a given embodiment. A “Commercial Scale” version is the large version for a given embodiment. Each level of power operation requires different techniques and materials to operate successfully.

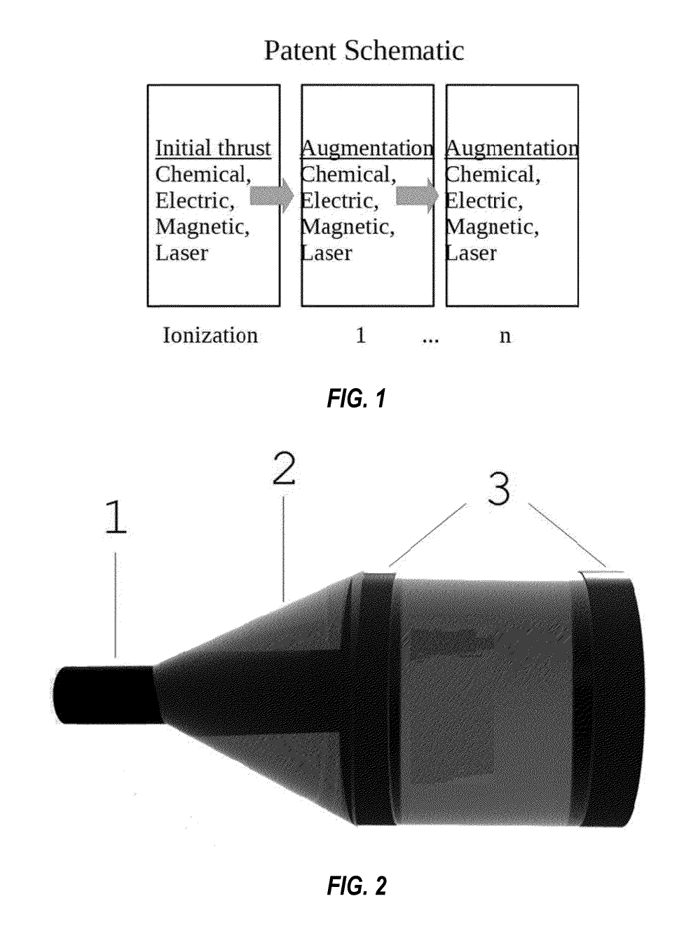

The rocket thrust equation is Force=Mass*Velocity. Solving the rocket thrust equation for maximum force quickly shows that increasing mass ejected leads to decreasing dividends in terms of payload. Thus to decrease fuel costs and increase the amount of thrust, the velocity of the exhaust must be increased. Embodiments of the present invention comprise at least two parts, which can be substituted in different orders and quantities. These parts comprise chemical (C), electrical (E), laser (L), and magnetic (M) components, where any two or more of them are used in combination to increase the velocity of the produced thrust. The present invention may be used not only for propulsion by generated or augmented thrust but also for radiation shielding or power generation. Augmented ionization methods, such as secondary ionization, vector addition, and critical ionization velocity may be used to increase the amount of thrust by increasing the amount of ionized material which can be accelerated by electromagnetic methods. Superconductive electromagnetic coils can be used to augment the velocity without additional power input. In one embodiment of the invention thrust can be produced by such coils without additional power input by using naturally occurring electromagnetic fields. As shown in FIG. 1, schematically this can be diagrammed as an ionization stage, followed by stages which add to the velocity or ionization of the working fluid (usually an ionized gas or plasma), using various methods. Using the first letter of the method, the two stage combinations can be listed as CC, CE, CM, CL, EC, EE, EM, EL, MC, ME, MM, ML, LC, LE, LM, and LL. With three stages the combinatorics lead to 64 different variations, with four stages 256 different variations, with five stages 1024 combinations, etc. A given method (such as lasers), can be used for ionization or acceleration, or both at the same time. For chemical stages, the stages after the first almost always comprise Vector Addition thrust chambers. U.S. Pat. No. 6,293,090 and U.S. Patent Application Publication No. 2012/0031070 A1 are examples of implementations of a magnetic component.

FIG. 2 illustrates a simple Electromagnetic/Magnetic embodiment of a secondary ionization chamber of the invention. This device is preferably enclosed to contain the bulk material, typically a gas. Plasma source 1 feeds a magnetic chamber, for example comprising a pair of permanent magnets 3, preferably comprising at least one Tesla field strength. The plasma produced by plasma source 1 reacts with bulk material 2 within the field of the magnetic chamber. The interaction between the plasma source and the bulk material preferably ionizes some of the bulk gas. The plasma from the plasma source and the ionized bulk gas are preferably further ionized by a Townsend cascade (where detached electrons in a magnetic field collide with other molecules and detach more electrons), so long as the magnetic field is approximately that of a solenoid, such that more of the bulk gas is ionized than the plasma source could produce unaided. Normally the length of the chamber is short, on the order of a few inches. A Townsend cascade can amplify ionization by over a million times at a cost of powering an electromagnetic field. The more intense the field, the more intense the ionization that is produced.

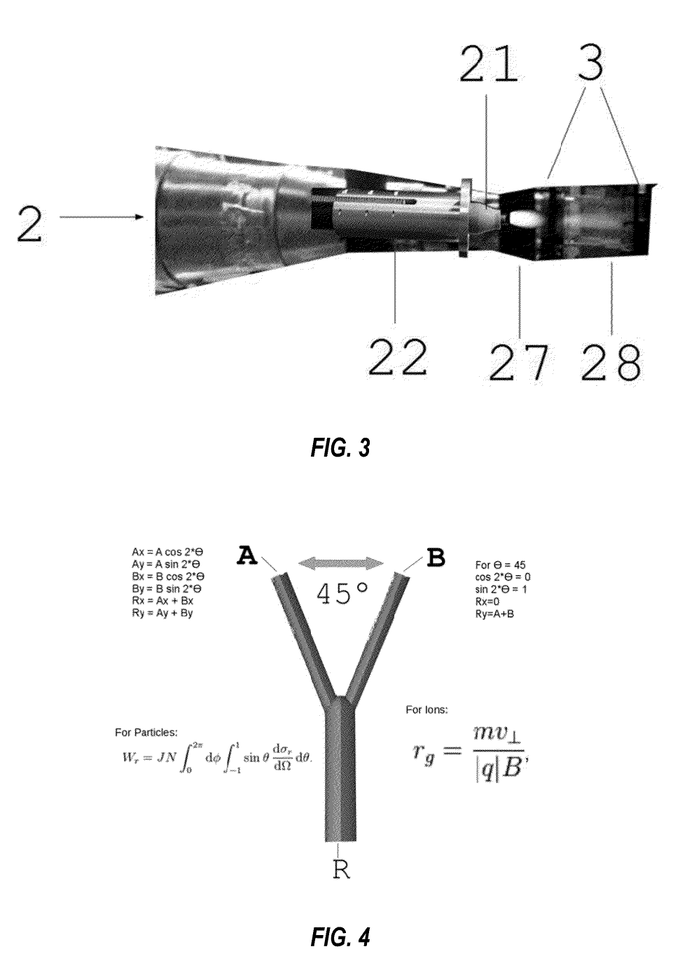

FIG. 3 is a photograph of an embodiment of a Blackjack secondary ionization demonstration of the present invention demonstrating a Townsend cascade or secondary ionization. Ductwork provides inlet 2 for an atmospheric gas. The plasma source preferably comprises plasma torch 21 held in place by a mounting 22. Plasma torch 21 generates flame 27 which interacts with bulk gas 2, producing the primary ionization. Permanent magnets 3 of the secondary ionization chamber interact with the ions, propelling them along the field lines of the approximately solenoid magnetic geometry, producing secondary ionization 28.

FIG. 4 illustrates a simple Chemical/Chemical embodiment of a vector addition thrust chamber of the present invention. Because vector addition works by collision, and because neutral gases collide infrequently due to the small size of the particles, for vector addition to work properly, ionized gases, which interact by their gyroradius cross section rather than their particle cross section (the gyroradius cross section being thousands of times larger), must be used. The included angle θ between the two streams determines the contribution of the velocity addition, reaching a maximum of doubling the velocity at 45 degrees. Two vectors A, B represent the mean flow path of their respective gas flows combined in a thrust chamber by vector addition, as modified by the probability of the particles gyroradius colliding, producing a result vector R. So the thrust augmentation consists of x % of unaltered thrust A and B and (100-x %) of doubled thrust R, where x is the percent of the bulk gas that is not ionized. In addition to the ionization percentage of the gases flowing along vectors A and B, the exhaust pressure and the exhaust velocity determine the likelihood of collisions. In general, greater exhaust velocity occurs near the final stages, and greater pressure occurs in smaller thrust chambers. The unaltered thrust is roughly equivalent to the percentage of neutral (un-ionized) gas. Vector addition can double the velocity for fully ionized gases. Normally the lengths of the sides of the chambers are short, preferably on the order of a few inches to help reduce the recombination of the input plasmas. The materials the chamber is made of are typically high temperature paramagnetic materials, such as ceramics, titanium, quartz, etc.

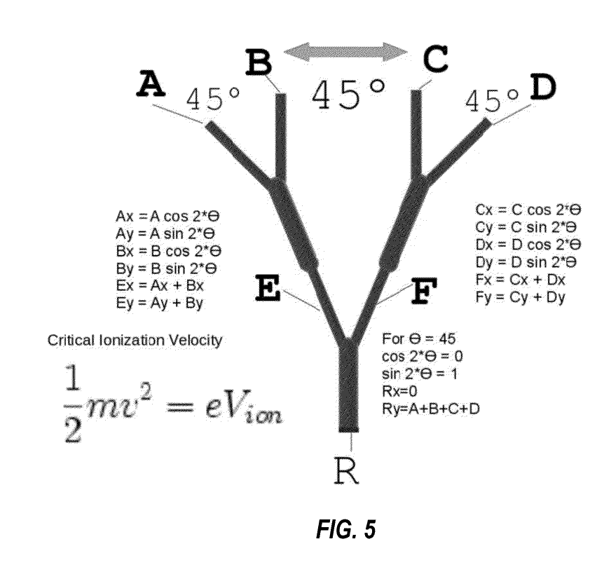

FIG. 5 shows a Chemical/Chemical/Chemical embodiment of a vector addition thrust chamber of the present invention. Vector addition can be added sequentially to multiply the velocity of the input plasma. Four vectors A, B, C, D representing the mean flow path of their respective gas flows are combined in a thrust chamber by vector addition, as modified by the probability of the particles' gyroradi colliding, producing result vectors E, F. The two vectors E and F represent the mean flow path of their respective gas flows combined in a thrust chamber by vector addition, as modified by the probability of the particles gyroradius colliding, producing a result vector R. This utilizes another ionization tool, the Critical Ionization Velocity. The four streams are combined to produce up to four times the velocity. The critical ionization velocity occurs when the velocity of the plasma stream exceeds the velocity equivalent to the ionization energy of the neutral gas. If the four streams are 3.5 km/s rocket exhaust with plasma torch ionization, the final exhaust velocity can reach 14 km/s. If the four streams are 10 km/s plasma torch exhausts, the final exhaust velocity can reach 40 km/s.

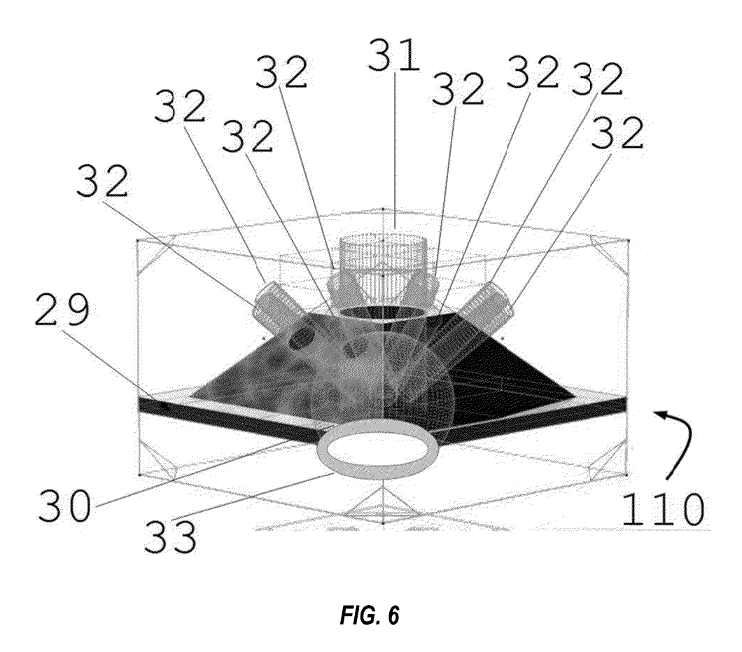

FIG. 6 shows an embodiment of a Blackjack vector addition ionization chamber 110, which comprises a single stage vector addition combined with a secondary ionization. Bulk gas is input through cylindrical shaft 31 into the body of ionization chamber 29. Ionization chamber 29 preferably comprises a square baseplate upon which a truncated pyramid is disposed. Hemisphere 30 is carved out of ionization chamber 29, at the intersection of internal cylindrical shaft 31 and the bottom of ionization chamber 29. Preferably a pair of tubes 32 are inserted into drilled holes in each face of the truncated pyramid, preferably such that they all point toward the centroid of the intersection of cylindrical shaft 31 and hemisphere 30. Each pair of tubes are preferably at a 45 degree angle to each other. This apparatus thus utilizes four pairs of single stage vector addition, with cancellation of any x axis drift. If each tube transports 3.5 km/s rocket exhaust with plasma torch ionization, the final exhaust velocity can reach 7 km/s. If the eight streams are 10 km/s plasma torch exhausts, the final exhaust velocity can reach 20 km/s. The shocked flow of the four vector addition result streams will provide additional thrust through shock lensing. Additional velocity can be obtained from the solenoid formed by permanent magnet 33 at the bottom of the chamber, forming a secondary ionization with the plasma torch arcs, and the magnetohydrodynamic (MHD) acceleration of the solenoid. For the plasma torch case, as long as the bulk gas input has a velocity of less than 6 km/s, the Critical Ionization Velocity, as discussed below, will completely ionize oxygen, carbon, nitrogen, and neon neutral gases within the bulk gas, since those gases have Critical Ionization Velocities of less than the velocity difference between the plasma torch exhaust velocity and the bulk gas velocity (in this example, 14). This limits such an engine to 13,421 mph within Earth's atmosphere. Thus in this and other embodiments herein, there are three different methods of ionization used: primary ionization due to plasma torches (or electric thrusters) of the plasma torch or thruster feed gas and the bulk gas; Critical Ionization Velocity ionization of certain components in the bulk gas; and secondary ionization due to a Townsend cascade.

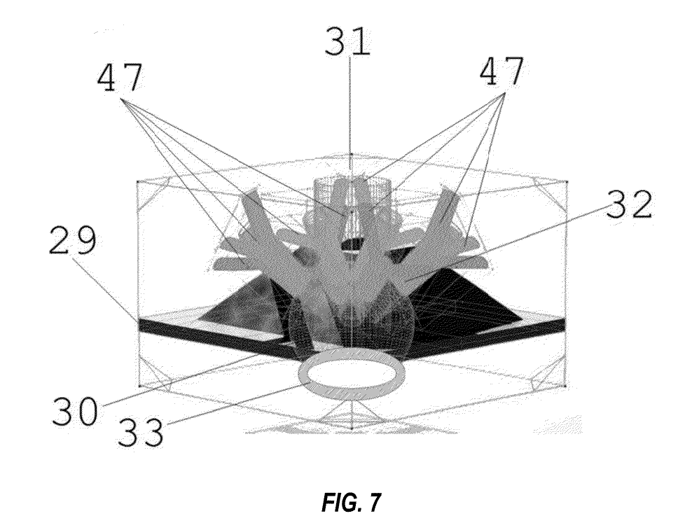

FIG. 7 shows the Blackjack Commercial Scale Vector Addition Chamber, which utilizes a dual stage vector addition combined with a secondary ionization. The bulk gas is input through cylindrical shaft 31 in the body of ionization chamber 29, which comprises a preferably square baseplate upon which a truncated pyramid is disposed. Hemisphere 30 is carved out of ionization chamber 29, at the intersection of internal cylindrical shaft 31 and the bottom of ionization chamber 29. Pairs of tubes are inserted into the face of each side of the pyramid such that they all point at the centroid of the intersection of cylindrical shaft 31 and hemisphere 30, while each pair is also preferably at a 45 degree angle to each other. This apparatus utilizes four pairs of single stage vector addition, with cancellation of any x axis drift. Each of the eight tubes are fitted with an additional vector addition pair of tubes 47. For each pyramid face the four tubes 47 correspond to the vectors A, B, C, D of FIG. 5. If each tube 47 transports 3.5 km/s rocket exhaust with plasma torch ionization, the final exhaust velocity can reach 14 km/s. If the stream in each tube 47 is 10 km/s plasma torch exhaust, the final exhaust velocity can reach 40 km/s. The shocked flow of the four vector addition result streams will provide additional thrust through shock lensing. Additional velocity can be obtained from the solenoid formed by permanent magnet 33 at the bottom of the chamber, forming a secondary ionization with the plasma torch arcs, and the MHD acceleration of the solenoid. For the plasma torch case, as long as the bulk gas input has less than 25 km/s velocity, the Critical Ionization Velocity will completely ionize oxygen, carbon, nitrogen, and neon neutral gases within the bulk gas (since the velocity difference is 40−25=15 km/s). This limits such an engine to 55,923 mph within Earth's atmosphere.

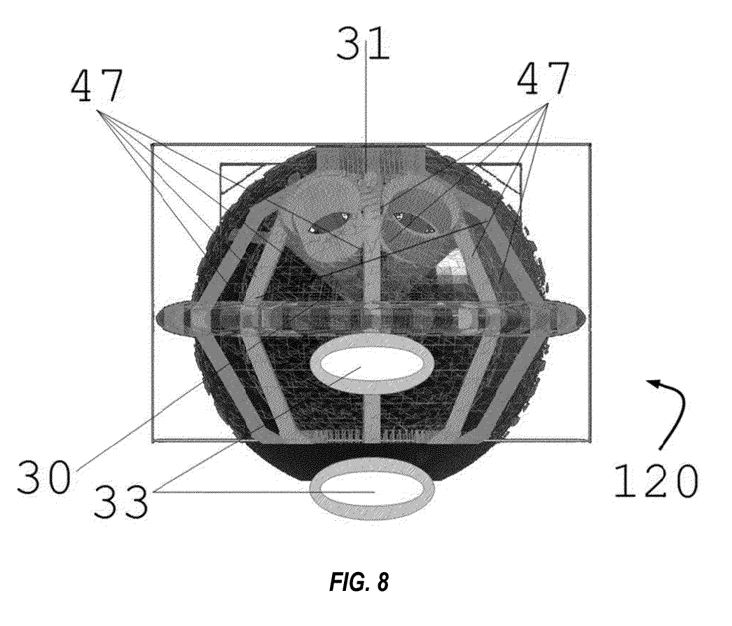

FIG. 8 shows the exterior of Blackjack Commercial Scale Vector Addition Thrust Chamber 120, where the assembly of FIG. 7 is in the interior of spherical thrust chamber 120 preferably such that the base of the pyramid rests at the centerline of the sphere. The plasma torch tubes 47 can be extended to the surface of the sphere, or can be accessed by ports cut into the sphere. Thrust chamber 120 can also have regenerative coolant passages cut into it, since despite the chamber itself preferably comprising ceramic, quartz, titanium, or TiAl6-4 alloy, it will be exposed to temperatures that will destroy it in minutes if it is not cooled. Such chambers may be constructed by normal subtractive manufacturing techniques, cut along the horizontal centerline and assembled in halves, or 3D printed by additive manufacturing techniques. Such chambers are preferably also treated by hot isostatic pressing (HIP) to reduce even microscopic voids and increase resistance to the high pressures encountered in the thrust chamber. Optional second magnet 33 at the base of the sphere connects and extends the secondary ionization magnetic field to the MHD coil which follows.

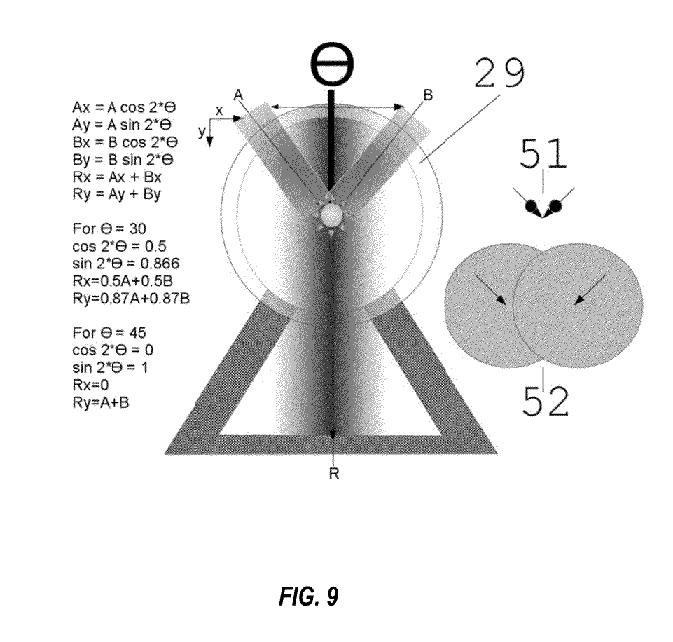

FIG. 9 shows the importance of the axis angle Θ, which is the included angle in which the partially or fully ionized streams A, B intersect in the vector addition thrust chamber; varying the angle dramatically alters the result flow R. For Θ=30°, there is a sideways component equal to the velocity of either flow, while the vertical component is reduced to a maximum of 1.74 times the velocity of either flow. For Θ=45°, there is no sideways component, and the vertical component is the fully doubled thrust of the original velocity of either flow A, B. The probability of particle collision 51 is low and the probability of gyroradius intersection (and thus electromagnetic collision) for ionized streams 52 is far greater. For highly ionized plasmas in a magnetic field, the probability approaches unity, provided the area of intersection is on the order of centimeters.

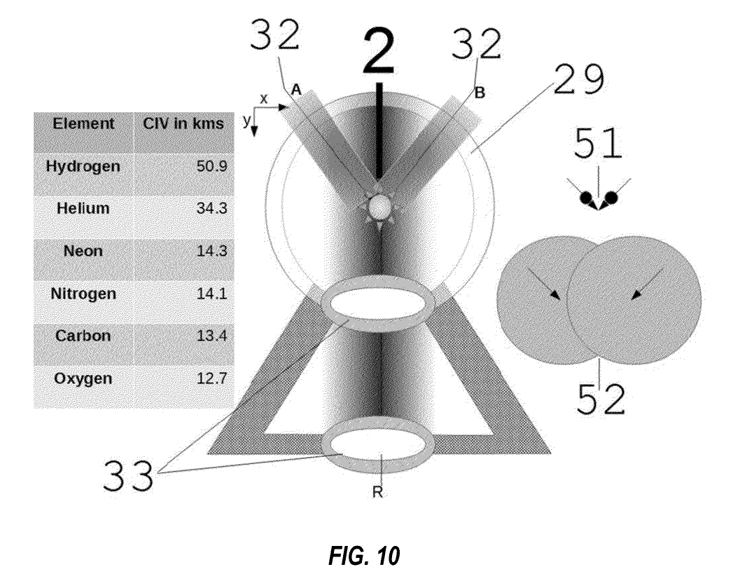

FIG. 10 shows the importance of Critical Ionization Velocity ionization. When the difference in velocity between the stream of bulk material 2 and the streams from tubes 32 and/or 47 along vectors A, B (Vdiff) exceeds the Critical Ionization Velocity (Vciv) for a given element, essentially every molecule of the element in the stream will be ionized. Additional velocity will be acquired by the stream of bulk material 2 in inelastic collisions 51 with the A, B streams or in gyroradius-mediated electromagnetic collisions 52 with the A, B streams. Additional velocity will be acquired through shock lens focusing of the A, B streams encountering the bulk material stream. Velocities in the A, B streams will form a distribution from 10 km/s to 40 km/s, skewed heavily toward the high end, within the region encountering where they encounter the bulk material stream. Townsend ionization completes the ionization, and additional velocity will be acquired by J×B interaction with the solenoid magnetic fields of magnets 33.

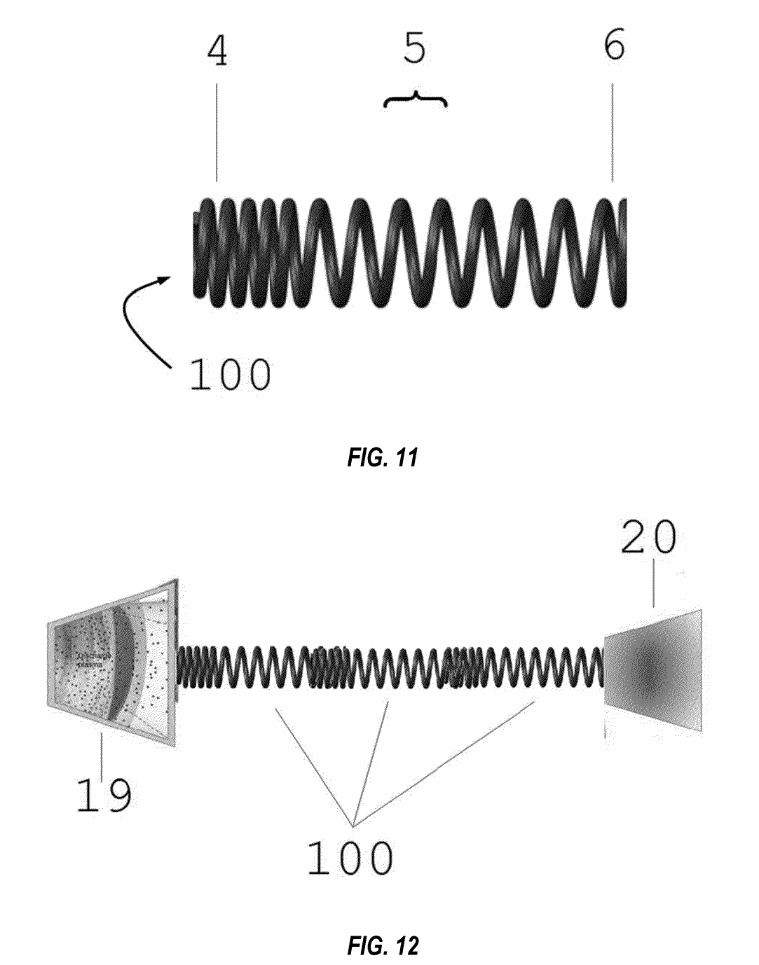

FIG. 11 shows logarithmic coil 100, which preferably comprises permanent magnetic, electromagnetic, or superconductive materials. It is approximately a solenoid, having a logarithmic coil spacing and implementing a conical geometry in a cylindrical physical structure. High spatial frequency coils 4 create a region of intense magnetic concentration. A low power logarithmic progression of coil spacing 5 slowly increases the distance between the windings and reduces the magnetic concentration. This forms a conical magnetic geometry within a cylindrical physical geometry, which implements a pressure gradient with inherent translational force. Lower spatial frequency coils 6 create a region of less intense magnetic concentration. The overall effect is the same as the thrust nozzle of a rocket, compression then expansion. It may be resistive or steady state (superconductive), implementing thrust by the J×B or Lorentz electromotive force. The higher the strength of the magnetic field, the higher the thrust, and superconductive coils can carry far more amperage than resistive coils. The greatest advantage of superconductive coils is the availability of “persistent mode”, where the coil can be put into a closed loop to run continuously without further energy input for months at a time, other than the cost of cryogenic cooling. Such coils can also implement the bias coils of a Field Reversed Configuration (FRC, also known as theta-pinch), which uses a second set of coils to generate a short lived rotating magnetic field. The rotating magnetic field coils of a FRC or theta-pinch setup are AC or RF coils, incompatible with being superconductive. However, heavy amperage bias field coils are quite compatible with superconductive (or DC) coils.

FIG. 12 shows the Blackjack Ion Thruster embodiment of the invention, a MHD enhanced version of NASA's NEXT ion thruster. Electric thrusters have high velocity but low total thrust due to low mass. Higher thrust is possible without any additional power input by using superconductive coils to accelerate the output of the thruster. The thruster can be any of the common types (ion, hall effect, arcjet, resistojet, plasma, MPD, pulsed, helicon, VASIMR, etc.) provided the result is ionized. The coils can add 35 km/s to 75 km/s velocity per meter of coil length. For NEXT ion thruster 19, producing 145 km/s, a three meter long coil 100 could add 105 km/s to 225 km/s, resulting in a 250 km/s to 370 km/s final velocity of exhaust 20. Such coil could be continuous or segmented into joined sections, for example sections 4, 5, 6. Alternatively, as shown, three one meter long coils 100, each coil comprising sections 4, 5, 6, can sequentially be used. In such embodiment spacings in each corresponding section 4, 5, 6 of successive coils 100 will be different depending on the application. FRC techniques can increase this to 225 km/s per meter at the cost of input power, resulting in 820 km/s. A non-FRC implementation of a coil 100 meters long could add 7500 km/s to the exhaust velocity, at only the cost of cryocoolers, while the velocity of an FRC implementation (22,645 km/s) could approach 10% of the speed of light (c=299,792.458 km/s). A kilometer long coil could produce a velocity that approaches the speed of light itself. The Large Hadron Collider at CERN consists of a 27-kilometer ring of superconducting magnets, so such structures are within technological reach.

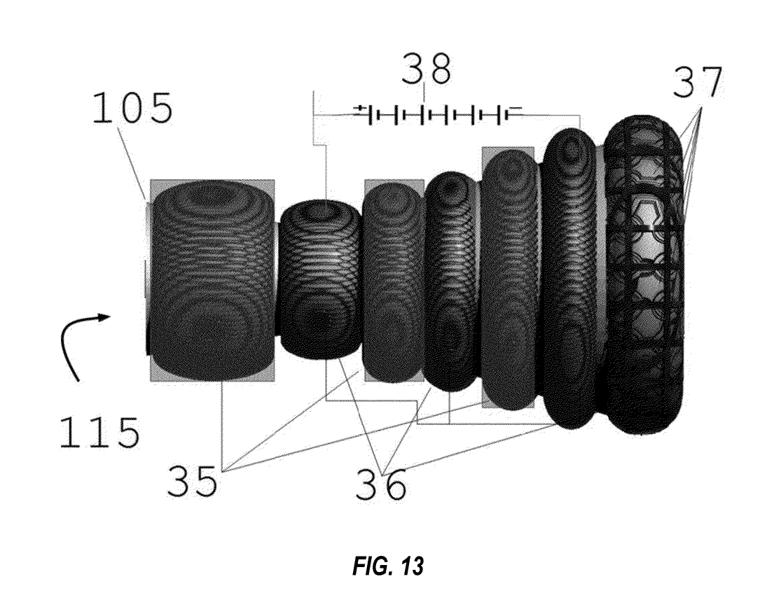

FIG. 13 shows a Plasmoid exhaust nozzle 115 comprising exhaust nozzle body 105, which typically comprises TiAl64 formed as a hollow cone, one or more MHD-A throat coils 35 wrapped around the cone, one or more MHD-G generator coils 36 wrapped around the cone, one or more MHD-A “steering coils” 37 wrapped around the edge of the outside end of the cone, and one or more charging systems 38 to feed the extracted electrical power to other equipment. Steering coils 37 preferably comprise separately activated portions of a larger coil that can be selectively turned on or off, or varied in amplitude relative to the other segments, to steer the vehicle. The classic Plasmoid Exhaust Nozzle is an electromagnetic coil system with two types of coils: MHD-A (“accelerator”) coils which can be resistive or superconducting, used for magnetic insulation (“throat coils”) and thrust vectoring (“steering coils”); and MHD-G (“generator”) coils which are used to extract ionization energy from the exhaust to power the craft, which have to be AC. The exhaust nozzle body can also be gold plated, coated with aerogel and titanium oxide for IR insulation, or regeneratively cooled, just like any of the thrust chambers.

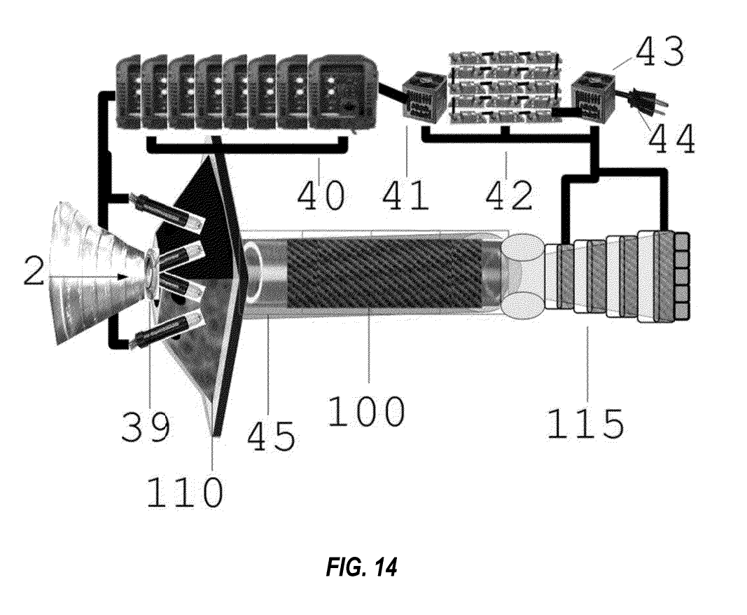

FIG. 14 shows a Blackjack Shrike Engine embodiment of the invention which takes in bulk gas 2 (typically atmosphere), feeding it through bulk mass control throttle 39, which preferably comprises an iris valve, into a Blackjack vector addition ionization chamber 110, which feeds a quartz tube 45 to contain the bulk gas which the MHD coils 100, with or without FRC, are formed around (cryostat and cryocooler not shown) (the acceleration subsystem), where the ionized and accelerated gas exits through Plasmoid exhaust nozzle 115. The power subsystem operates as follows: the charging portion of the plasmoid exhaust nozzle feeds power to charging power controller 43 which charges supercapacitor array 42, and may also provide conditioned external wall power 44 to charge the coils. Optional inverter 41 feeds power to one or more plasma torch power supplies 40 capable of powering the plasma torches used in the ionization subsystem (for example eight). The MHD-A coils can be extended to increase power generation, and turbines can be used to extract rotational energy or used as generators. Throttle can be directly controlled by using the flow control iris to increase or reduce flow, the ionization subsystem can be reduced in amperage, or even turned off after reaching the ionosphere.

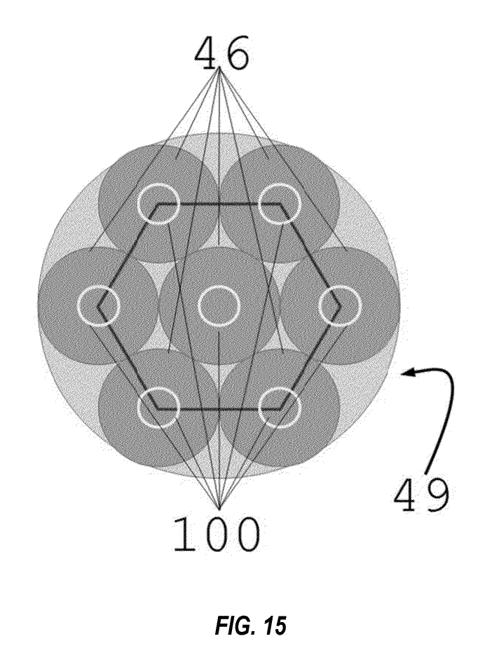

FIG. 15 shows a cross sectional view of an embodiment of a Blackjack Commercial Scale Cryostat consisting of seven Logarithmic MHD coils 100, each formed on (encircling) a tube 45 (comprising quartz, titanium, etc.), each contained within a Cryostat enclosure with conductive cryocooler 46. Additional supporting structures, such as ducting on each end are not shown. The Blackjack Commercial Scale Cryostat deals with the scaling problem: as the mass flow is increased, so does the load on the coils. At the amperage maximum of the coils, the coils begin to overheat, leading to catastrophic coil failure. Dividing the flow between multiple parallel coils brings the flow level down by the number of coils. While seven coils are shown here, any multiple of coils can divide the flow at the cost of the increased mass for each coil; the number or length of coil segments can also be varied.

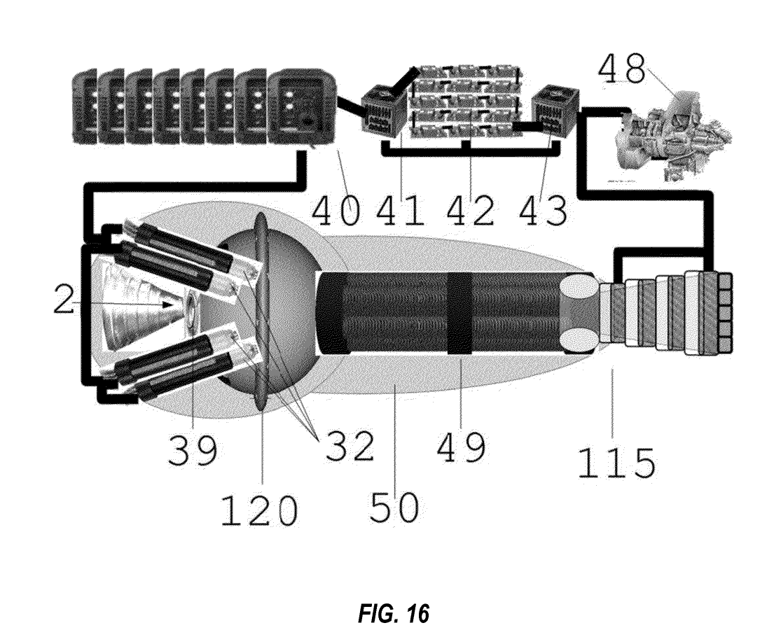

FIG. 16 shows the Blackjack Commercial Scale Engine embodiment of the invention which takes feeds bulk gas 2 (preferably Earth's atmosphere) through bulk mass control throttle 39 (preferably comprising an iris valve) into the Blackjack Commercial Scale Vector Addition Thrust Chamber 120, where it interacts with 16 plasma torches in two stage vector addition, thus being ionized. The ionized gas is then accelerated by Blackjack Commercial Scale Cryostat 49 (i.e. the acceleration subsystem), which preferably comprises seven three meter long tubes, and is expelled through the Plasmoid Exhaust Nozzle. For the power subsystem, together with the charging portion of Plasmoid Exhaust Nozzle 115, a preferably 450 KW Auxiliary Power Unit 48 provides power to charging power controller 43, feeding supercapacitor array 42 and the plasma torch power supplies 40 through inverter 41. The entire engine or any portion thereof can be enclosed in exterior aerodynamic shell 50, although the APU and power subsystem may be located elsewhere in the body of the craft. The MHD-A coils can be extended to increase power generation, and turbines can be used to extract rotational energy or used as generators. Throttle can be directly controlled by using the flow control iris to increase or reduce flow, the ionization subsystem can be reduced in amperage, or even turned off after reaching the ionosphere.

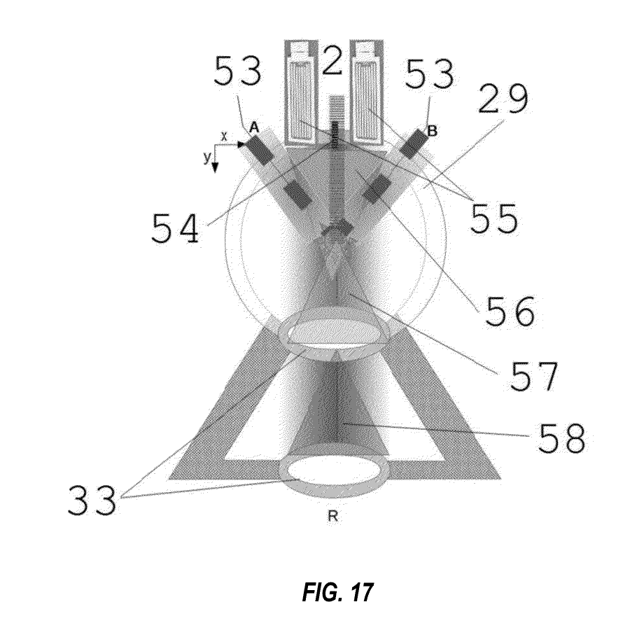

FIG. 17 shows a Laser Wakefield Vector Addition Thrust Chamber where the partially ionized bulk mass stream 2 enters the vector addition ionization chamber 29 after having been exposed to preferably four ozone ionization pads 55, which ionize the oxygen in the bulk gas. Ionization chamber 29 can also comprise the pyramidal design used in the previous Blackjack embodiments. The partially ionized bulk gas 56 enters the chamber. Laser diodes shine into the vector addition thrust chamber along the same paths that plasma torches would in the previous embodiments. For example, 4×4 kw laser diodes 53 preferably frequency doubled to 532 nm (green) enter along vector A, and 4×4 kw laser diodes 53 preferably frequency doubled to 532 nm (green) enter along vector B, forming ionized channels of gas within the hemisphere at the center of the thrust chamber. Some vector addition of the ionized A, B channel pairs occurs, but not to the same extent as when plasma torches are used. At the top of the thrust chamber where the bulk gas stream enters, every 90 degrees 4×4 kw trigger laser diodes 54 frequency doubled to 266 nm (UV), amplified, pulse shaped, and q-switched to 10 femtosecond pulses are focused at the center of the thrust chamber, where the twelve laser channels combine to produce laser wakefield 57, ionizing nitrogen gas in the bulk gas input and accelerating it towards two permanent magnets 33 forming a Townsend ionization chamber where ionized oxygen and nitrogen produce further ionization in Townsend cascade 58. This ionization system is designed for FRC/MHD coils, which can use bulk gas ionized at low levels (1% to 5%) and still effectively accelerate it. The tradeoff between ionization and FRC coil power cost is made explicit. Also, the laser photons have no gyroradius, and do not interact, while the ions they have created do. The ion channels created by the lasers provide high intensity standing waves for the wakefield.

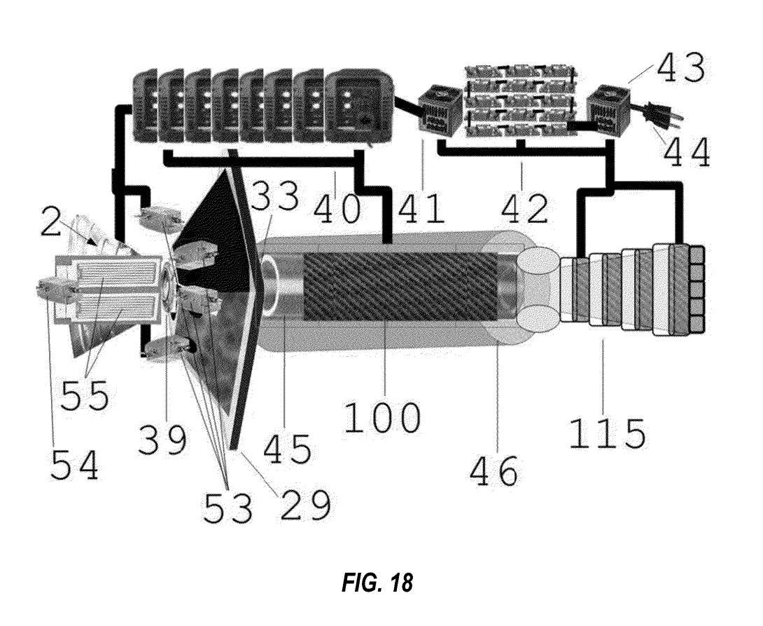

FIG. 18 shows a Blackjack Laser Wakefield Engine embodiment of the invention which feeds bulk gas 2 (typically atmosphere) through iris-valved bulk mass control throttle 39 into a Laser Wakefield Vector Addition Ionization subsystem, which in turn feeds an acceleration subsystem comprising quartz tube 45 which the MHD coils, preferably with FRC, are formed around, inside cryostat and cryocooler 46. The ionized and accelerated gas proceeds to the power subsystem through a Plasmoid Exhaust Nozzle. The charging portion of the plasmoid exhaust nozzle feeds power to charging power controller 43, which charges supercapacitor array 42 and may also provide conditioned external wall power 44 to charge the coils. Inverter 41 feeds power to the laser diode and ozone pad power supplies 40, in this case one or more power supplies capable of powering the laser diodes. The MHD-A coils can be extended to increase power generation, and turbines can be used to extract rotational energy or used as generators. Throttle can be directly controlled by using the flow control iris to increase or reduce flow, and the ionization subsystem can be reduced in amperage, or even turned off after reaching the ionosphere.

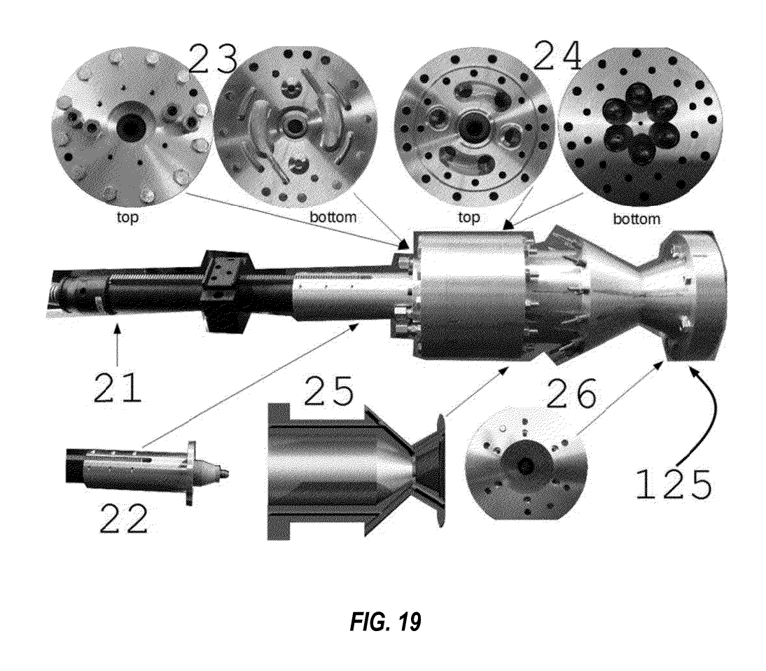

FIG. 19 shows a Hammerhead Rocket Motor assembly embodiment 125 of the invention, which combines the ionization of a plasma torch with the secondary ionization of the Townsend cascade formed between the arc of the plasma torch and the permanent magnet. Plasma torch 21 is inserted into plasma torch mounting 22, which is then inserted into the top plate 23 which comprises one or more fuel/oxidizer inlets and distribution with a graphite plasma torch insulator insert in the center. Bottom plate 24 performs fuel-oxidizer distribution with graphite plasma torch insulator and spray nozzles. The plasma torch, plasma torch mounting, top plate, bottom plate, and thrust chamber 25 are preferably bolted together with seals as necessary. Thrust chamber 25 comprises regenerative cooling and sensor ports and is bolted to permanent magnet holder and thrust chamber bottom plate 26. With additive manufacturing, the top and bottom plates can be printed as a single part, and the thrust chamber and bottom plate can be printed as a single part.

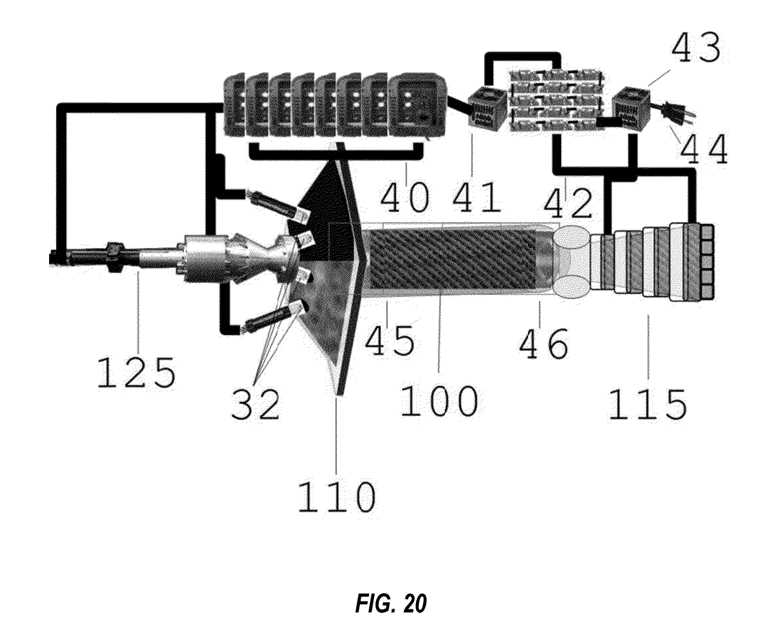

FIG. 20 shows the Hammerhead Shrike Rocket Engine embodiment of the invention which uses Hammerhead Rocket Motor assembly 125 to provide partially ionized bulk gas into a Blackjack Vector Ionization subsystem 110 which feeds acceleration subsystem comprising tube 45 (preferably comprising quartz, titanium, etc.) on which MHD coils 100, with or without FRC, are formed, along with a cryostat and cryocooler 46, and then the ionized and accelerated gas exits through power subsystem comprising Plasmoid Exhaust Nozzle 115. The charging portion of the plasmoid exhaust nozzle feeds power to the charging power controller 43, which charges supercapacitor array 42, and may also provide conditioned external wall power 44 to charge the coils. Inverter 41 feeds power to the plasma torch power supplies 40, in this embodiment one or more power supplies capable of powering nine plasma torches (8 for the ionization subsystem and one for the Hammerhead Rocket Motor). The MHD-A coils can be extended to increase power generation, and turbines can be used to extract rotational energy or used as generators.

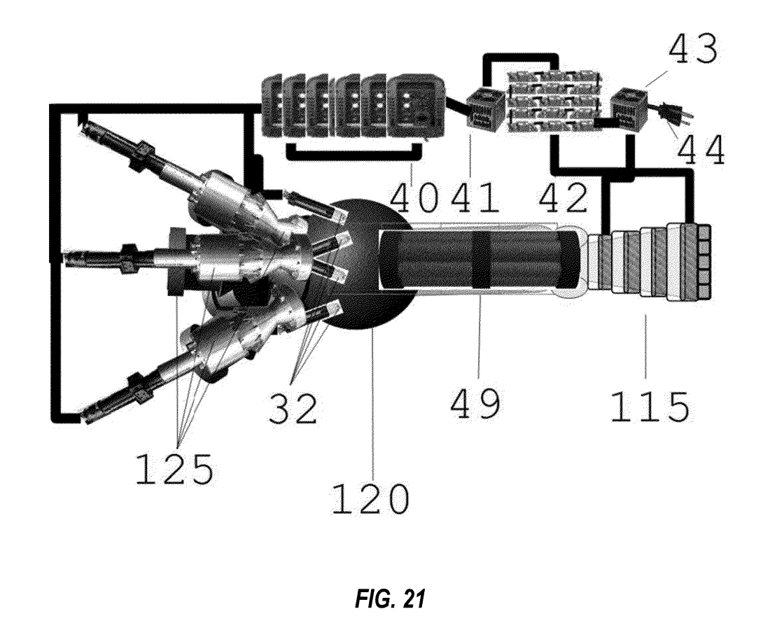

FIG. 21 shows the Hammerhead Commercial Scale Rocket Engine embodiment of the invention which uses four of the Hammerhead Rocket Motors 125 to provide partially ionized bulk gas into a Blackjack Commercial Scale Vector Ionization subsystem from FIG. 8, which feeds an acceleration subsystem comprising a commercial scale cryostat 49 as shown in FIG. 15, preferably with seven tubes, three meters long. The ionized and accelerated gas exits to a power subsystem through a Plasmoid Exhaust Nozzle. The charging portion of the plasmoid exhaust nozzle feeds power to charging power controller 43, which charges supercapacitor array 42, and may also provide conditioned external wall power 44 to charge the coils. Inverter 41 feeds power to the plasma torch power supplies 40, in this case one or more power supplies capable of powering twenty plasma torches (four for the Hammerhead Rocket Motor and 16 for the ionization subsystem). The MHD-A coils can be extended to increase power generation, and turbines can be used to extract rotational energy or used as generators.

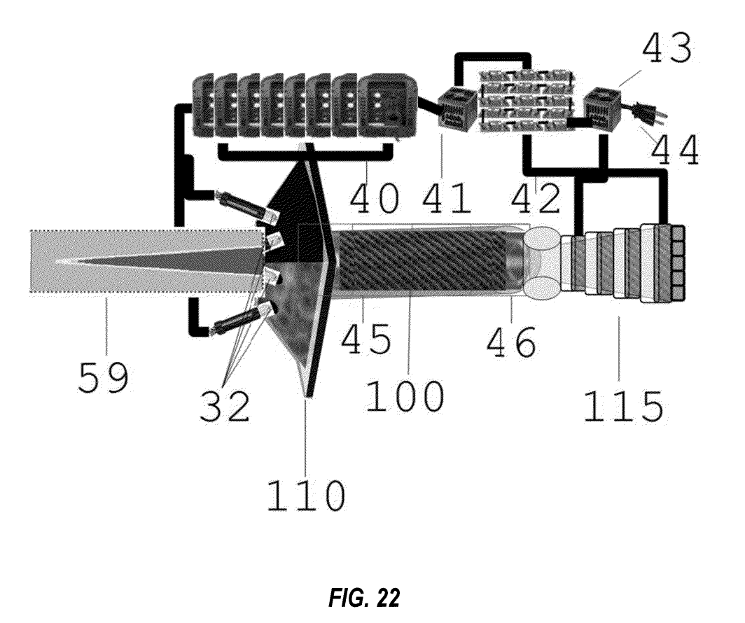

FIG. 22 shows the Longbow Shrike Rocket Engine embodiment of the invention which uses a solid rocket motor 59 to provide partially ionized bulk gas into a Blackjack Vector Ionization subsystem 110, which feeds acceleration subsystem comprising a tube 45 (preferably comprising quartz, titanium, etc.) around which one or more MHD coils 100, with or without FRC, are formed, with cryostat and cryocooler 46. The ionized and accelerated gas exits to the power subsystem through a Plasmoid Exhaust Nozzle 115. The charging portion of the plasmoid exhaust nozzle feeds power to charging power controller 43, which charges the supercapacitor array 42, and may also provide conditioned external wall power 44 to charge the coils. Inverter 41 feeds power to the plasma torch power supplies 40, in this embodiment one or more power supplies capable of powering the eight plasma torches used for the ionization subsystem. The MHD-A coils and/or turbines can be used to extract power from the exhaust.

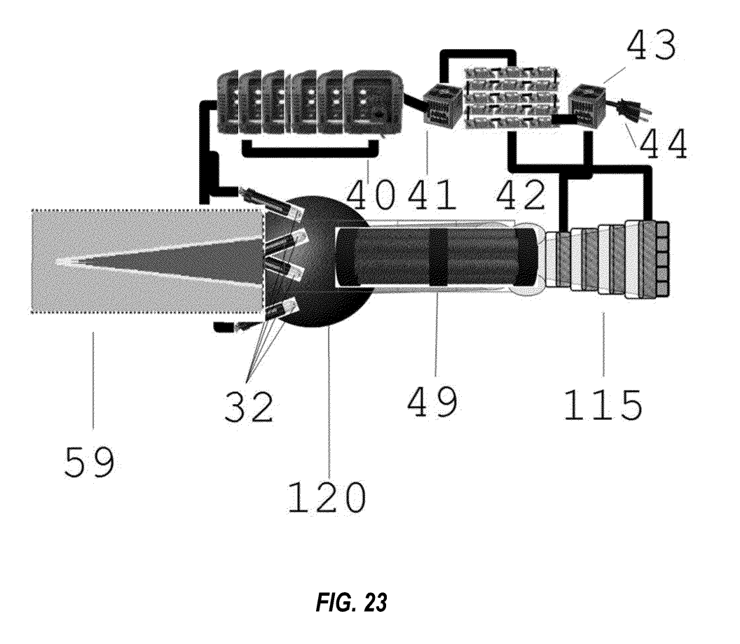

FIG. 23 shows the Longbow Commercial Scale Rocket Engine embodiment of the invention which uses solid rocket motor 59, which may be of hybrid design, to provide partially ionized bulk gas into Blackjack Commercial Scale Vector Ionization subsystem 120, which feeds an acceleration subsystem comprising commercial scale cryostat 49, preferably with seven tubes, three meters long. The ionized and accelerated gas exits to a power subsystem through a Plasmoid Exhaust Nozzle 115. The charging portion of the plasmoid exhaust nozzle feeds power to charging power controller 43, which charges supercapacitor array 42 and may also provide conditioned external wall power 44 to charge the coils. Inverter 41 feeds power to plasma torch power supplies 40, in this case one or more power supplies capable of powering the sixteen plasma torches used for the ionization subsystem, or equivalently electric thrusters which each produce more than 1,000 lsp. The MHD-A coils and/or turbines can be used to extract power from the exhaust.

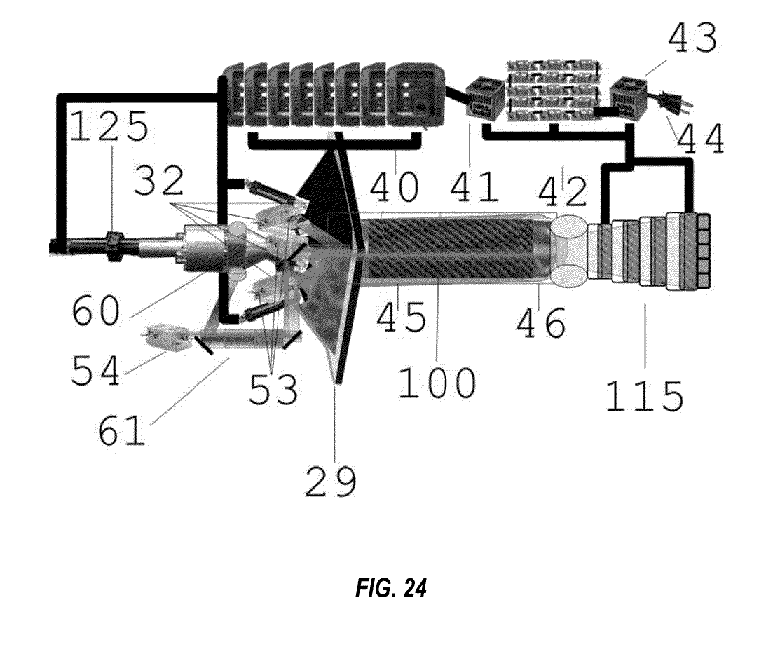

FIG. 24 shows the Plasmoid Shrike Rocket Engine embodiment of the invention, which combines chemical laser 60 formed across the body of the thrust chamber 25 of Hammerhead Rocket Motor 125. The Hydrogen/Fluorine reaction produces 2700 nm photons, which can be doubled twice to 675 nm, or three times to 337 nm; since plasma is opaque to laser light in proportion to frequency, shorter wavelengths produce higher densities (and greater velocities). The ionization subsystem is more complicated, because it combines the laser wakefield of FIG. 17 with the high power Hydrogen/Fluorine chemical laser with amplification, frequency doubling, pulse shaping optical subsystem 61 and the Blackjack Vector Ionization subsystem of FIG. 20. Acceleration and power subsystems complete the engine.

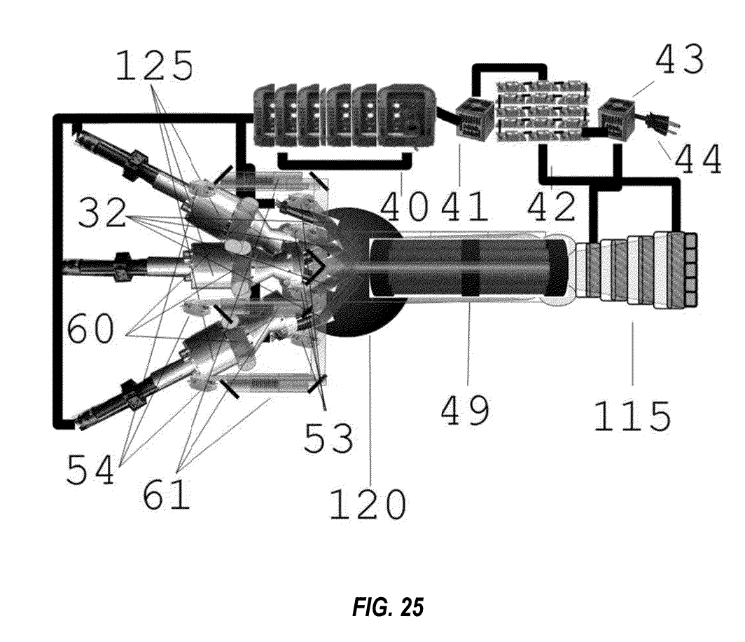

FIG. 25 shows the Plasmoid Commercial Scale Rocket Engine embodiment of the invention, which uses four of the chemical laser enhanced Hammerhead Rocket Motors, each combining a chemical laser 60 formed across the body of thrust chamber 25 with Hammerhead Rocket Motor 125. The Hydrogen/Fluorine reaction produces 2700 nm photons, which can be doubled twice to 675 nm, or three times to 337 nm; since plasma is opaque to laser light in proportion to frequency, shorter wavelengths produce higher densities (and greater velocities). The ionization subsystem is more complicated, because it combines the laser wakefield of FIG. 17 (using a total of 48 laser diodes, 32 ionization diodes and 16 trigger diodes 54) with the high power Hydrogen/Fluorine chemical laser with amplification, frequency doubling, pulse shaping optical subsystem 61 (preferably one for each rocket motor) and the Blackjack Commercial Scale Vector Ionization subsystem of FIG. 21. Acceleration and power subsystems complete the engine.

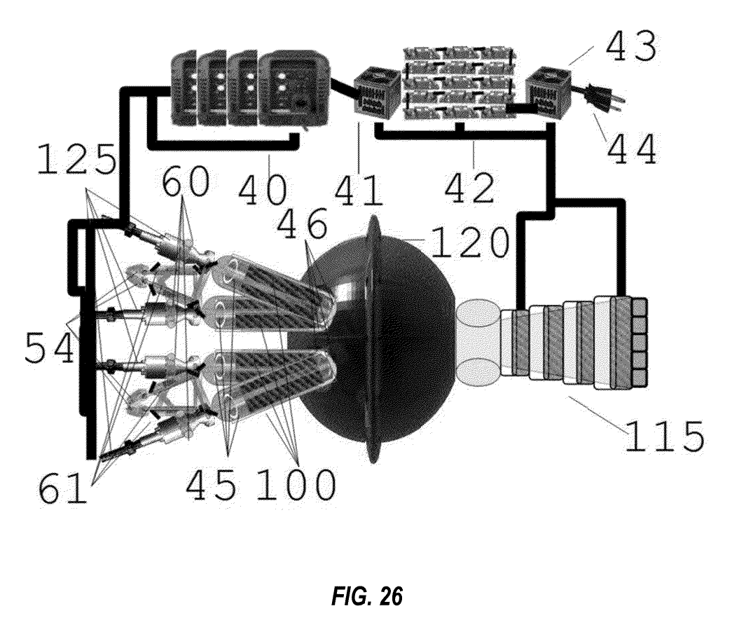

FIG. 26 shows the Classic Plasmoid Rocket Engine embodiment of the invention, which uses four of the chemical laser enhanced Hammerhead Rocket Motors, combining chemical laser 60 formed across the body of the thrust chamber 25 of the Hammerhead Rocket Motor FIG. 19. The Hydrogen/Fluorine reaction produces 2700 nm photons, which can be doubled twice to 675 nm, or three times to 337 nm; since plasma is opaque to laser light in proportion to frequency, shorter wavelengths produce higher densities (and greater velocities). Laser wakefield trigger diodes 54 are combined in the same optical path as each of the chemical lasers, after the amplification, frequency doubling, pulse shaping of the chemical laser subsystem 61 (preferably one for each rocket motor). Each rocket motor then feeds into its own MHD coil subsystem, each end of which comprises a permanent magnet, one in each motor, and one between each motor and Vector Addition Thrust Chamber (29), to form two Townsend cascades. The power subsystem completes the engine. The coils must work harder in this design.

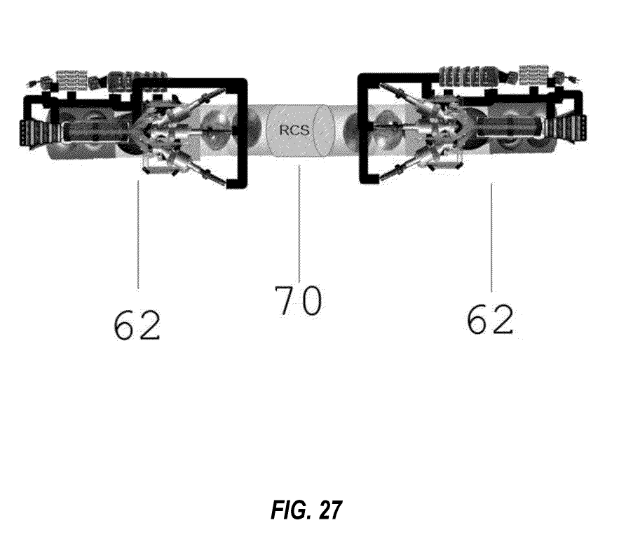

FIG. 27 shows the Third Law Drill embodiment of the invention, constructed from two Plasmoid Commercial Scale Rocket Engines 62 as shown in FIG. 25, set on the same axis to cancel out their thrust, aided by Reaction Control System 70 built from cubesat avionics and small maneuvering thrusters to correct for X/Y drift as the drill acts upon material in the Z axis. Steering coils in the rocket engine nozzles can also be used by the RCS to maintain or alter position. This drill can cut rock or metal at high rates of speed. This drill enables drilling in zero gravity, where the thrust from one engine performs the drilling, and the thrust from the other engine holds the drill in place.

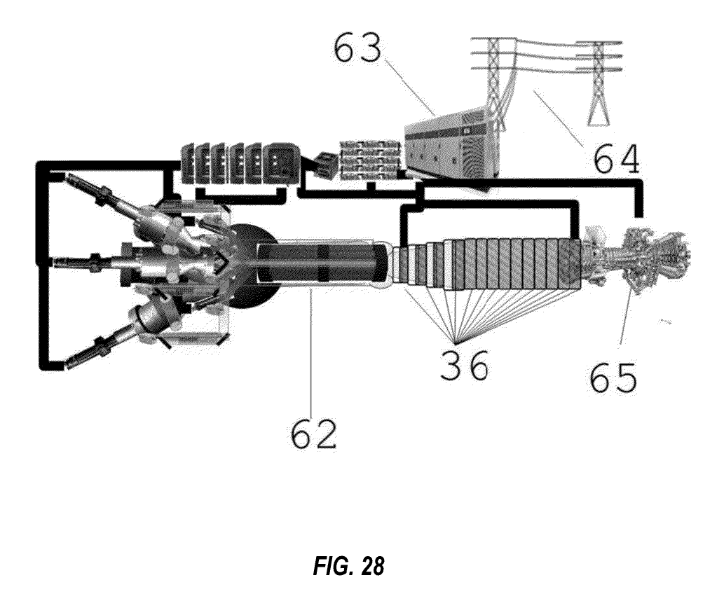

FIG. 28 shows the Plasmoid Commercial Scale Power Generator embodiment of the invention, with a Plasmoid Commercial Scale Rocket Engine 62 shown in FIG. 25. However, in this embodiment, the engine feeds an extended series of MHD-G coils 36, extracting the ionization energy from the bulk gas. Steering coils 37 are not required in this embodiment. This power is then fed into industrial scale power conditioning equipment 63, which then feeds the power grid 64. Additional energy is preferably extracted from the exhaust by one or more turbine generators 65 and supplied to power conditioning equipment 63. Given the HF chemistry, this system would only be suitable for off world power generation, unless substituted with one of the other hydrogen/oxidizer laser types, such as HO, HI, HBr, or HCl, where hydrogen/oxygen would be the preferred chemistry.

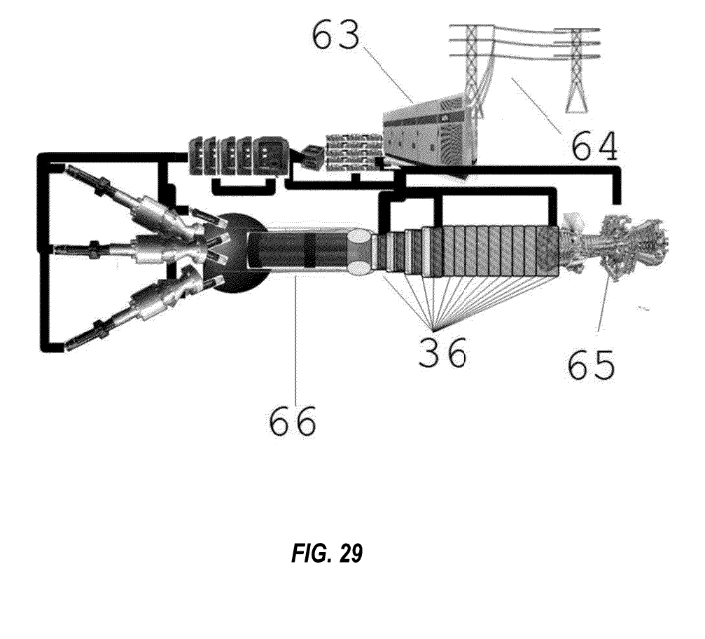

FIG. 29 shows the Hammerhead Commercial Scale Power Generator embodiment of the invention, with a Hammerhead Commercial Scale Rocket Engine 66 as shown in FIG. 21. However, in this embodiment the engine feeds an extended series of MHD-G coils 36, extracting the ionization energy from the bulk gas. Steering coils 37 are not required in this embodiment. This power is then fed into industrial scale power conditioning equipment 63, which then feeds the power grid 64. Additional energy is preferably extracted from the exhaust by one or more turbine generators 65 and supplied to power conditioning equipment 63. The Hammerhead engine can use any one of the traditional liquid rocket engine chemistries, such as Hydrogen/LOX, Kerosene/LOX, Methane/LOX, Hydrazine/Nitrogen Tetra oxide, etc. A laser wakefield subsystem can be added to tailor ionization and acceleration.

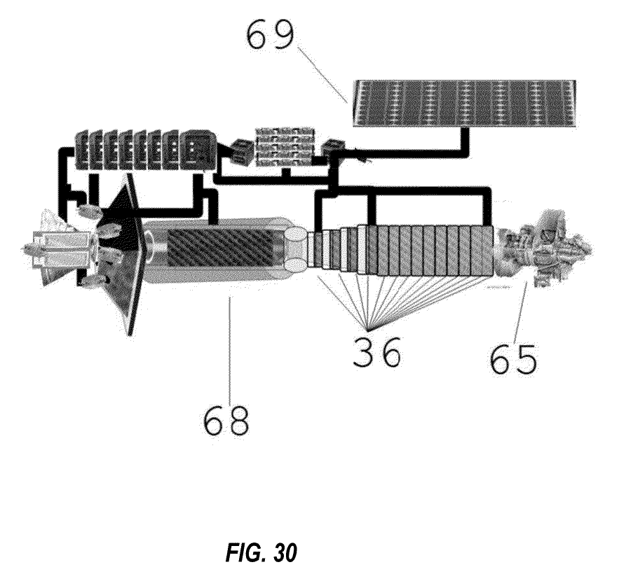

FIG. 30 shows the Blackjack Small Scale Power Generator embodiment of the invention, with a Blackjack Shrike (Laser Wakefield) Engine 68 as shown in FIG. 18. However, in this embodiment the engine feeds an extended series of MHD-G coils 36, extracting the ionization energy from the bulk gas. Steering coils 37 are not required in this embodiment. This power is then fed into charging power controller 43. Additional energy is extracted from the exhaust by one or more turbine generators 65 and supplied to the power controller. Solar panel 69 can charge the supercapacitor array to start the engine.

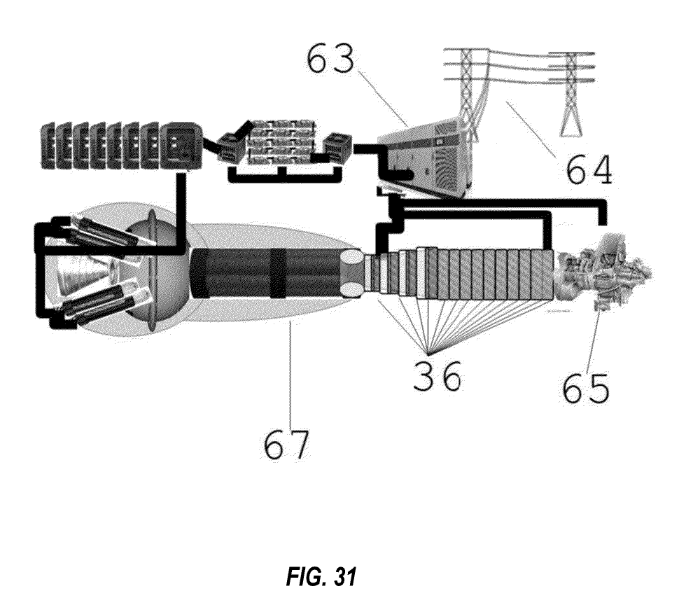

FIG. 31 shows the Blackjack Commercial Scale Power Generator embodiment of the invention, with a Blackjack Commercial Scale Rocket Engine 67 as shown in FIG. 16. However, in this embodiment the engine feeds an extended series of MHD-G coils 36, extracting the ionization energy from the bulk gas. Steering coils 37 are not required in this embodiment. This power is then fed into industrial scale power conditioning equipment 63, which then feeds the power grid 64. Additional energy is extracted from the exhaust by one or more turbine generators 65 and supplied to power conditioning equipment 63. The design of this generator works in either Terran or Martian atmospheres, especially when a laser wakefield subsystem is added to tailor ionization and acceleration. Solar panels can be added for starting power if required.

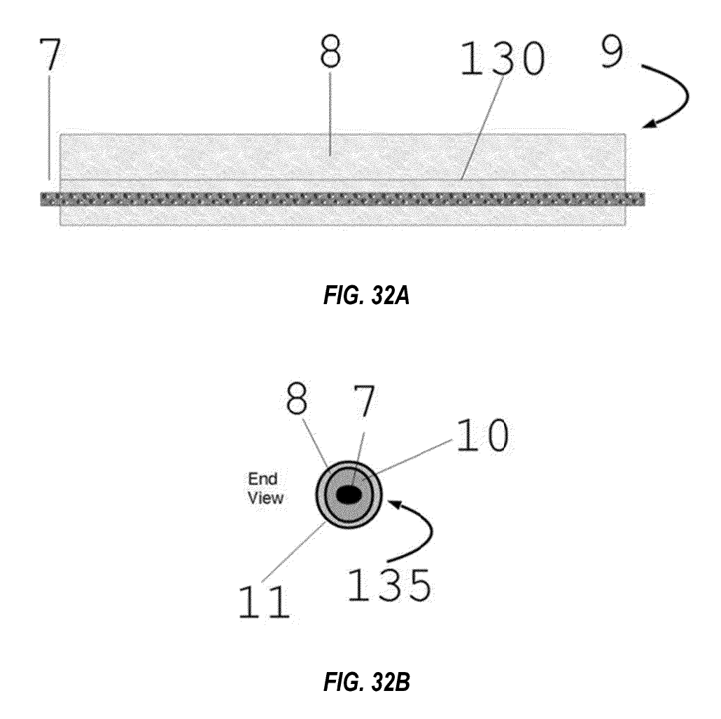

FIG. 32A shows an embodiment of a flat self-insulating superconductive cable of the present invention comprising high temperature superconducting tape or wire 7 insulated by aerogel 8. Flat cable 9 may be created by folding aerogel sheet 8 along fold line 130, and gluing the free long edges of aerogel sheet 8 together with tape or wire 7 between them. This forms hollow region 10 which can be filled with a thermal inertia mass of cryogenic liquid. Alternatively, two aerogel sheets may be used, sandwiching tape or wire 7 and gluing them along both pairs of adjoining long edges. The cable is preferably cooled by a conductive cooler, while the cryogenic fluid provides thermal mass for insulation. Thus the individual cable segments can be completely sealed and do not require fluid pumping. Flat cable 9 can be used to form coils in or on spacecraft bodies. As shown in FIG. 32B, round cable 135 preferably comprises the same high temperature superconducting tape or wire 7 in the center, surrounded by cryogenic fluid 10 which is surrounded by aerogel 8 and encased in sheath 11 which preferably comprises infrared reflective mylar and Kapton, or woven carbon fiber composite, or both. Round cable can be used to form coils inside the spacecraft body.

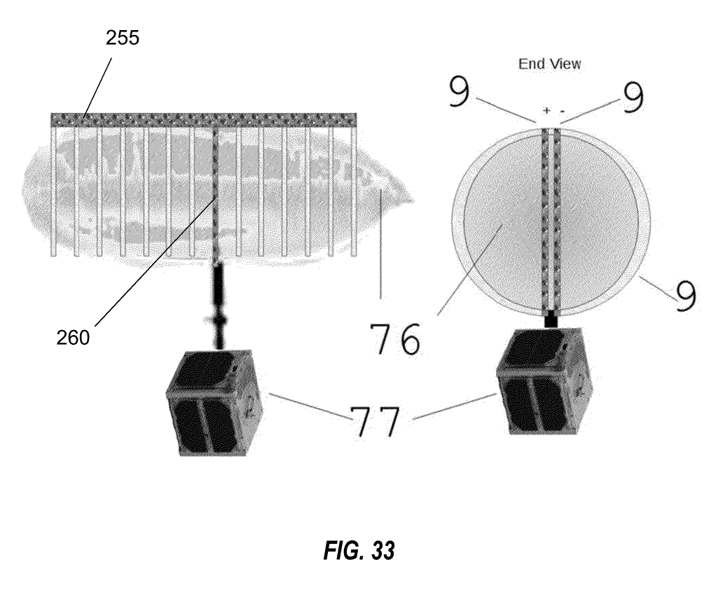

FIG. 33 shows side and end views of the SharkFin Primitive Magnetic Sail embodiment of the invention which relies on the Earth's Magnetosphere or Heliosphere for the ionization stage. The Lorentz electromotive thrust is provided by coils preferably comprising flat cables 9 formed around the shape of chimney balloon 76, preferably one meter diameter by three meters long, filled with helium gas. The coils ends feed the plus and minus superconductive coil rails (buses) 255 across the top of the balloon, which connect to charging lines 260. The magnetic field radiates from the surface of the balloon outward, turning the balloon into the equivalent of a large bar magnet. The wire of the coils are preferably insulated by aerogel tape and conductively cooled by an external cryocooler, which is removed before launch, such that the coils are left in persistent mode. The aerogel tape tubes are preferably filled with liquid helium to reduce the time required for the cryocooler to cool down the coils to superconductive temperatures. For aircraft safety, the entire assembly may be coated and painted, with LED blinking lights affixed. GPS receiver and/or smartphone electronics in a cubesat form 77 can be used to monitor the progress of the prototype. An additional weather balloon may be used to provide lift to the stratosphere. The sail is designed to be launched between 100,000 and 200,000 feet above ground level. If oriented properly towards the south pole at launch, it should continue along the magnetic field lines up into space, past the crush point of the weather balloon. Ideally, it should follow the field lines of the Magnetosheath, until it connects with the Heliosphere field lines.

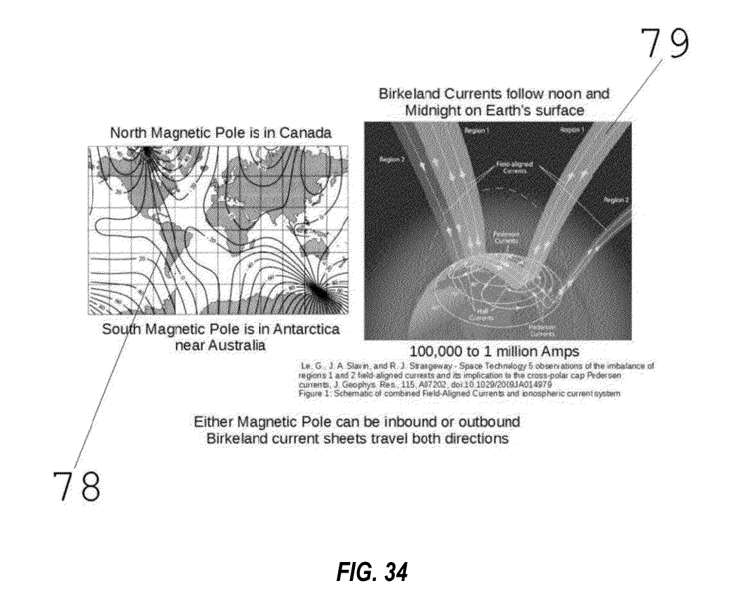

FIG. 34 shows the field lines 78 and the Birkeland current 79 of the earth's magnetosphere. Earth's magnetic field is comparatively weak near the surface, but magnets still align themselves with the lines of force. At stratospheric and ionospheric altitudes, the Birkeland current provides a powerful electromagnetic current (100,000 to 1 million amps); it is the physical mechanism behind the auroras we see near the poles. Magnetic engines must either follow the field lines or pay the fuel cost to deviate from them. Magnetic sails can accelerate or decelerate in these fields, reducing the cost of delivering payloads to space or returning them from space.

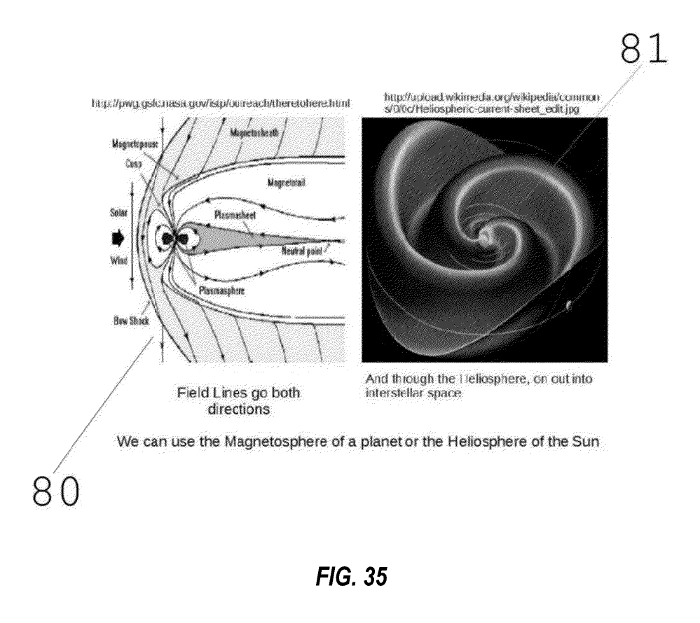

FIG. 35 shows the magnetosphere and heliosphere. Earth's magnetic field 80 provides power for magnetic sails, both inbound and outbound. The magnetic poles are essentially doorways on and off the planet, where we see charged particles in the auroras. The heliosphere 81 has a roughly 27 day cycle, where the high speed (800 km/s) solar current flows and elsewhere the low speed current is 350 km/s. Being able to tap even one percent of that current is the equivalent of the exhaust of our modern rockets, without the need to carry any fuel, capable of continuous acceleration and deceleration. There is one problem for the Sharkfin Primitive Magnetic Sail—once launched, it will follow the magnetic field to the pole, follow the Birkeland current on into the Magnetotail, and the heliosphere will sweep it out into interstellar space, while constantly accelerating it with no hope of slowing down or ever coming back. Return flight could be achieved by turning off the coil, reversing it, and turning it back on.

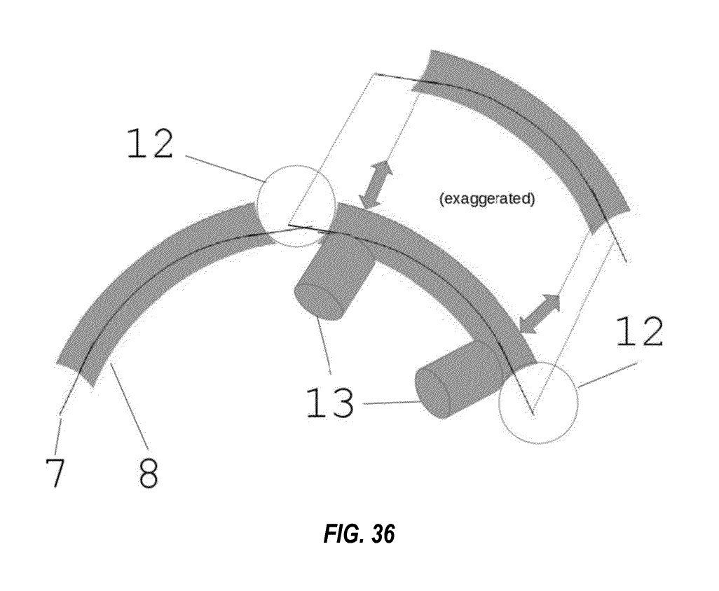

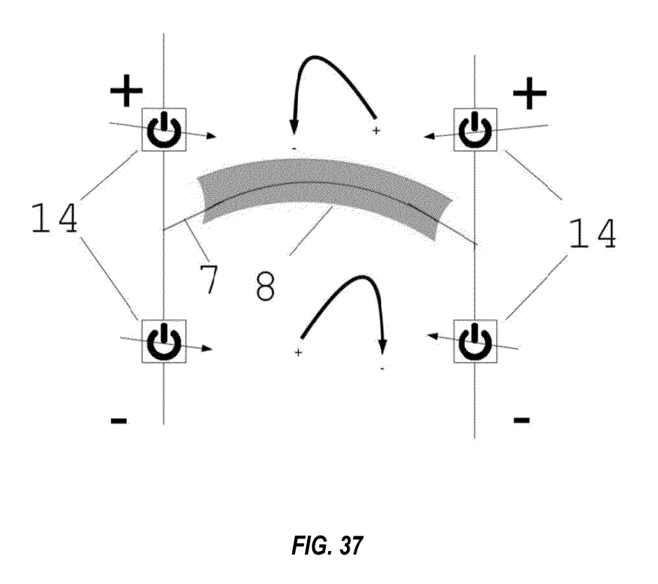

FIG. 36 shows a physical persistent mode switch which disconnects a coil segment from the remainder of the loop, shutting off the current. High temperature superconducting tape or wire 7 is surrounded by aerogel insulation 8, even where the coil segments meet in cryogenic cooling seals 12. Electric solenoids 13 preferably comprising mu-metal insulation move the ends of the cable segment to physically disconnect the electrical connection. The solenoids may use plastic rods or other standoffs to limit interference of the coils magnetic field, just as they use mu-metal magnetic insulation. The coil wire remains within the cryogenic seals, keeping the temperature at superconductive levels. Connections to the other coil segments can then be changed in polarity. FIG. 37 shows a polarity power switch, which uses four programmable power switches 14 to connect the removable coil segment 7 to power, enabling the coil to be switched from North/South to South/North orientation in flight. With the removable segment of the coil disconnected, the power switches can be configured in the desired configuration, the removable segment connected, and the coil charged. When the coil is charged the switches can be programmed to disconnect, leaving the coil in persistent mode. The connections remain physically connected within the aerogel insulation. Normal operation is to turn on diagonally opposite switches at the same time, such that the connection is positive to negative (left to right current flow) or negative to positive (right to left current flow). All four switches can be disconnected simultaneously to leave the coil in steady state (persistent mode) or turned off. A resistive persistent switch may still be used for convenience in charging.

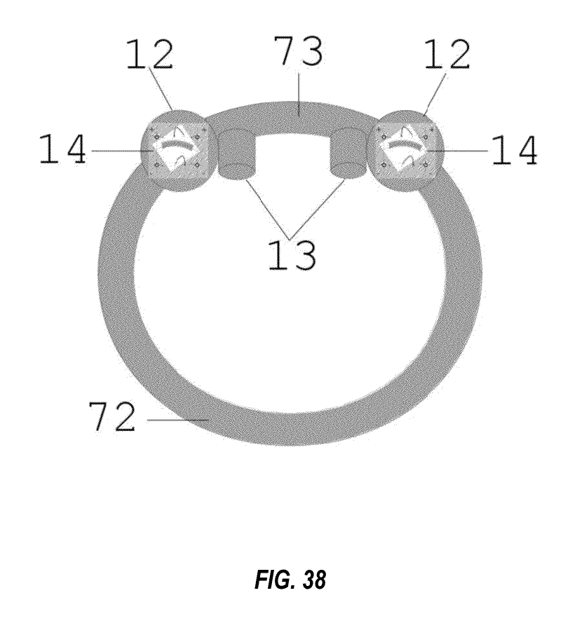

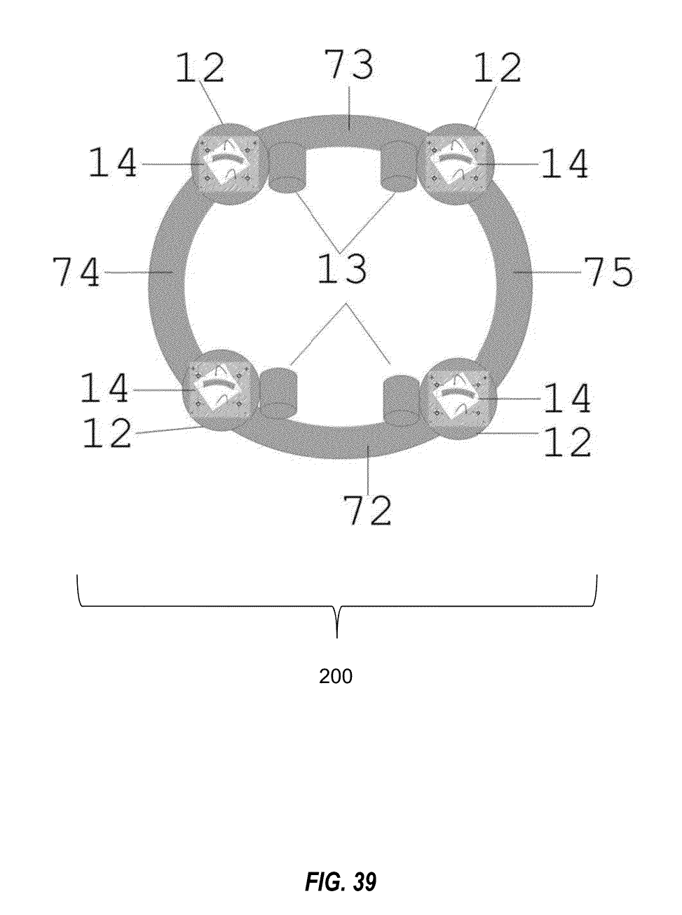

FIG. 38 shows a two segment reversible superconducting magnet, where two cryogenic cooling seals 12 keep the thermal inertia cryogenic fluid from leaking out. Electric solenoids 13 operate as shown in FIGS. 36-37 to connect or disconnect the segment, while the two connections to programmable switches 14 allow the polarity to be reversed (only one switch is required per coil). The lower coil segment, “Bias” or “Bottom”, 72 is preferably fixed physically. The upper coil segment 73, “Temporal” or “Top”, moves via solenoids 13 to disconnect the coil. Upper segment 73 may also use a “persistent mode switch”, whether ohmic or microwave, which is useful for draining the charge from the coils. When the coil is drained, the programmable switches can configure the coil, N-S or S-N (+/− or −/+). The coil can then be charged in the new configuration and the persistent mode enabled. FIG. 39 shows a four segment reversible superconducting magnet, where four cryogenic cooling seals 12 keep the thermal inertia cryogenic fluid from leaking out. Electric solenoids 13 operate as shown in FIGS. 36-37 to connect or disconnect each segment, while the four connections to programmable switches 14 allow the polarity to be reversed (only two switches are required per coil). Two successive corresponding seals 12, solenoids 13, and switches 14, together with their intervening coil segment such as lower coil segment 72, form solenoid assembly 200. The left 74 and right 75 coil segments are fixed physically. Lower coil segment 72, “Bias” or “Bottom”, moves via solenoids 13 to disconnect the coil. Upper coil segment 73, “Temporal” or “Top”, moves via solenoids 13 to disconnect the coil. Segments 72, 73 may also use a “persistent mode switch”, whether ohmic or microwave, which is useful for draining the charge from the coils. When the coil is drained, the programmable switches can configure the coil, N-S or S-N (+/− or −/+). The coil can then be charged in the new configuration and the persistent mode enabled. This design provides redundancy in shutting off a coil.

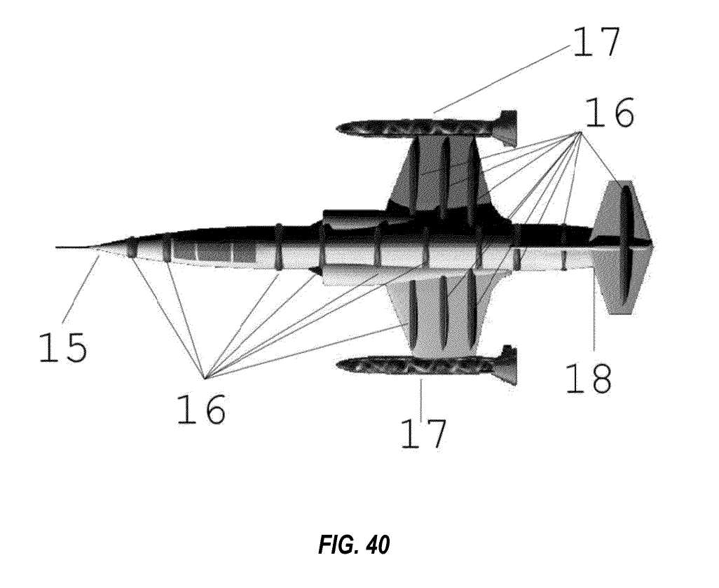

FIG. 40 shows an embodiment of a SharkFin magnetic sail, which relies upon the Magnetosphere 80 or Heliosphere 81 for the ionization stage. The Sharkfin magnetic sail comprises spacecraft 15 (example spacecraft based upon Lockheed F-104) where self-insulated superconductive coils 16 are embedded below the exterior skin of the craft, with optional Blackjack electric Jet engines 17 (coils may also be used, with the ionization stage turned on or off), and an optional Hammerhead liquid rocket engine 18 (rocket motor(s) turned off and/or the ionization turned off). The fuel used by the Sharkfin coils is provided by the Magnetosphere 80 or the Heliosphere 81, presuming the coils are charged and set in persistent mode, providing constant acceleration (or deceleration) by using the Lorentz electromotive field which naturally exists. Typically the superconducting cryocoolers used are provided by either Hammerhead or Blackjack engines, as are the charging and supercapacitor power subsystems. With the propulsion provided by an external force, just as in a traditional sailboat, long journeys can be accomplished at very low cost. In space, the continuous (1G to 2G) acceleration and deceleration reduces the travel time to any destination within the orbit of Jupiter to less than ten hours, and travel to the Moon to less than 15 minutes. Small steering coils can help modify the field to reduce the use of reaction control system thrusters. Just as the MHD coils are simple solenoids, Sharkfin turns the craft itself into a solenoid. Additional benefits include the magnetic fields enclosing the ship providing inherent radiation protection, and very low power costs (cryocooling and entropy recharge). Navigation of such a spacecraft is also very different, since direct paths are rarely possible. The spacecraft must follow the fields, and use them to accelerate or decelerate. Thus the navigation for such spacecraft consists of parabolic (or quadratic) courses.

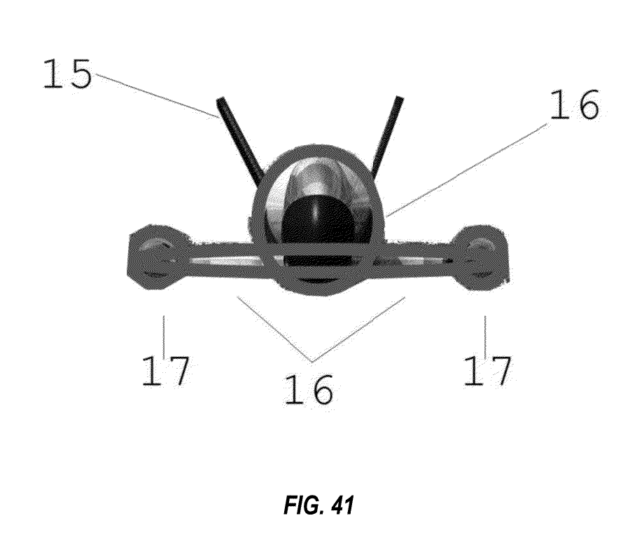

FIG. 41 shows the Sharkfin deceleration mode, where the 3D magnetic field is configured to oppose the electromagnetic field without flipping the craft to align with the exterior magnetic field. Example spacecraft 15 is based upon Boeing X-37B, with two Blackjack jet engines 17, one Hammerhead engine 18 (not shown), and Sharkfin magnetic sail coils 16. The coils of the magnetic sail are embedded in the body of the spacecraft, below the exterior skin of the craft. The coils of the Blackjack engines are used, with the ionization stage turned on or off. The 3D magnetic field responds to the magnetosphere 80 or heliosphere 81, producing continuous thrust while the coils are powered. To decelerate, coils at the edges of the craft must be set to opposite polarity, to keep the craft from flipping, while the main coils are set in opposition, in this diagram N-S-S-S-N, or S-N-N-N-S, where the coils for Blackjack engines 17 are set to the opposite of magnetic sail coils 16. The exterior coils are set to accelerate and the interior coils are set to decelerate.

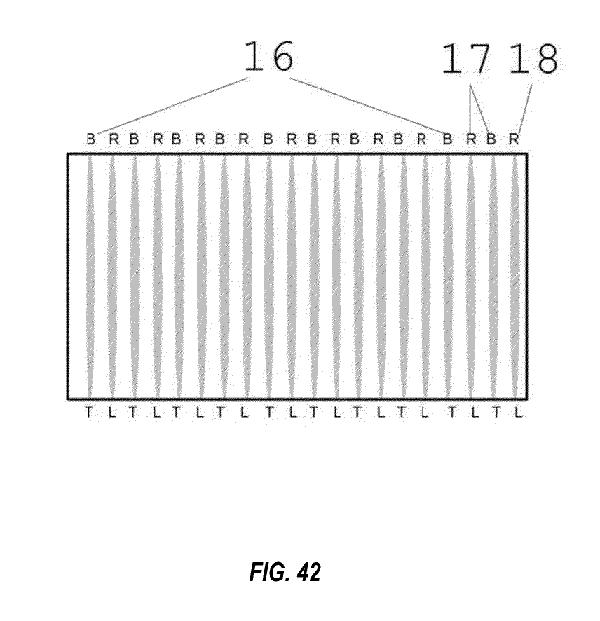

FIG. 42 is a schematic of a programmable, variable thrust coil controller for a variable thrust magnetic sail, where each self-insulated superconducting coil 16 comprises four segments. One pair of segments is fixed physically, alternating in adjacent coils between top/bottom and left/right pairs to provide redundancy in case of damage to the ship. The coils can be charged to different voltages or amperages to vary the magnetic field of the sail. Lower velocity may also be achieved by energizing fewer coils. The deceleration mode of FIG. 41 may also be implemented by charging coils of engines 17 and 18 coils to a reversed field, in essence turning the craft into an electromotive brake. Further tailoring of the crafts thrust vector may be obtained by varying the steering coils, at the cost of power. Such a variable thrust coil controller may be implemented in hardware (in the programmable switches) or in software (by controlling the individual switches), or a mixture of both.

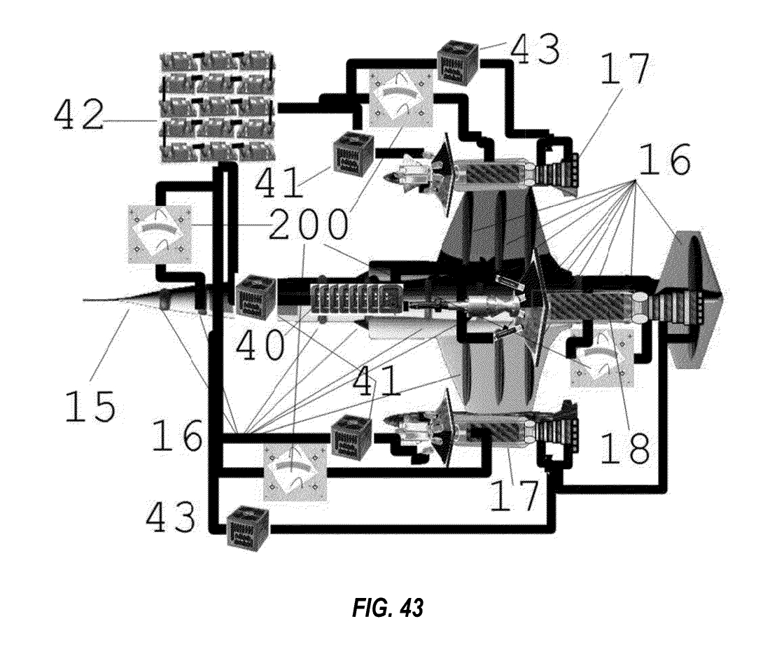

FIG. 43 shows an embodiment of the Sharkfin Shrike Magnetic Sail Engine, which relies upon the Magnetosphere 80 or Heliosphere 81 for the ionization stage. The Sharkfin Magnetic Sail comprises Spacecraft 15 (example spacecraft based upon Lockheed F-104) where self-insulated superconductive coils 16 are embedded below the exterior skin of the craft, with Blackjack Shrike electric jet engines 17 (coils are also be used, with the ionization stage turned on or off) (or alternatively Blackjack Shrike laser wakefield engine 68) and a Hammerhead Shrike liquid rocket engine 18 (rocket motor(s) turned off and/or the ionization turned off) (or alternatively Hammerhead Shrike Engine shown in FIG. 20). Each embedded self-insulated superconductive coil 16 has at least one segment and programmable power switches inside solenoid assembly 200. The power subsystem comprising above described components 40-43 is preferably shared between the three types of engines. The three types of engines are required to operate throughout the Earth/Mars/Moon system. Earth has atmosphere (for the Blackjack), a magnetosphere (for the Sharkfin), and a heavy gravity well (for the Hammerhead). Mars has an atmosphere, no significant magnetosphere, and a significant gravity well. The Moon has no atmosphere, no significant magnetosphere, and a small gravity well. The most efficient engine combination for a given environment can be chosen to minimize fuel expense, and trip length.

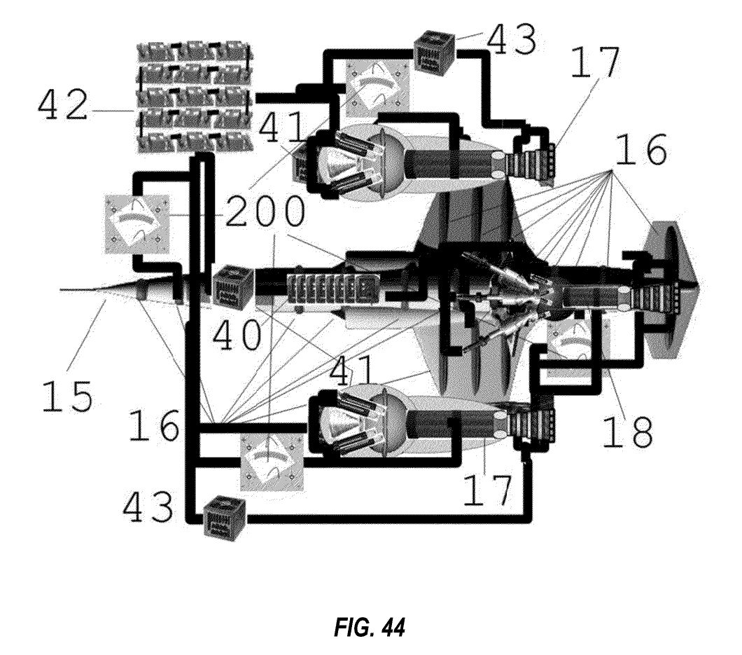

FIG. 44 shows an embodiment of the Sharkfin Commercial Scale Magnetic Sail Engine, which relies upon the Magnetosphere 80 or Heliosphere 81 for the ionization stage. The Sharkfin Magnetic Sail consists of spacecraft 15 (example spacecraft based upon Lockheed F-104) where self-insulated superconductive coils 16 are embedded below the exterior skin of the craft, with Blackjack Commercial Scale electric Jet engines 17 (coils are also be used, with the ionization stage turned on or off) (or alternatively Blackjack Commercial Scale engine 67) and a Hammerhead Commercial Scale liquid rocket engine 18 (rocket motor(s) turned off and/or the ionization turned off). Each embedded self-insulated superconductive coil 16 has at least one segment and programmable power switches inside solenoid assembly 200. The power subsystem comprising above described components 40-43 is shared between the three types of engines, but may have built in redundancy of components. The three types of engines are required to operate throughout the Earth/Mars/Moon system. Earth has atmosphere (for the Blackjack), a magnetosphere (for the Sharkfin), and a heavy gravity well (for the Hammerhead). Mars has an atmosphere, no significant magnetosphere, and a significant gravity well. The Moon has no atmosphere, no significant magnetosphere, and a small gravity well. The most efficient engine combination for a given environment can be chosen to minimize fuel expense, and trip length.

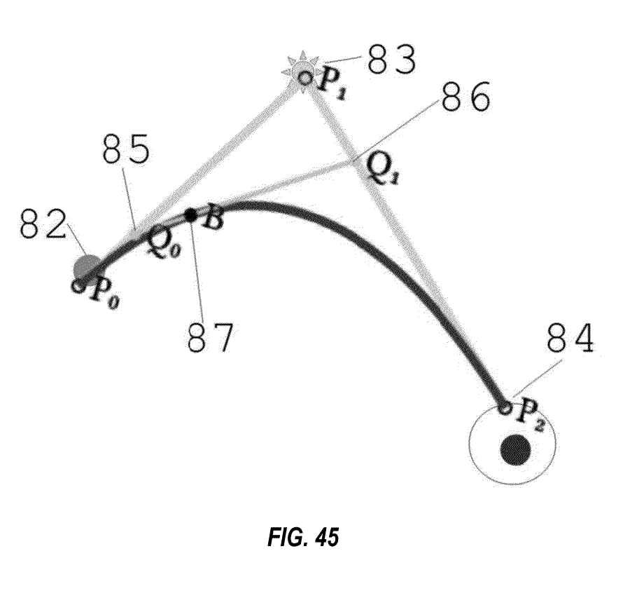

FIG. 45 shows a method for calculating parabolic magnetic courses, where the place of origin P₀ 82 is known in a co-ordinate system, the sun P₁ 83 has a known position, and the place of destination P₂ 84 also has a known position. The calculation uses three other points, Virtual Point Q₀ 85, Virtual Point Q₁ 86, and Bezier Curve Point B₀ 87. From Origin to Sun construct a centerline. From Destination to Sun construct a centerline. Fit a skewed asymmetric parabola with intercepts at the place of origin and place of destination bounded by the centerlines, using Bezier's method. Per Wikipedia (http://en.wikipedia.org/wiki/B % C3% A9zier_curve), for quadratic Bézier curves one can construct intermediate points Q0 and Q1 such that as t varies from 0 to 1 Point Q0(t) varies from P0 to P1 and describes a linear Bézier curve, Point Q1(t) varies from P1 to P2 and describes a linear Bézier curve, and Point B(t) is interpolated linearly between Q0(t) to Q1(t) and describes a quadratic Bézier curve.

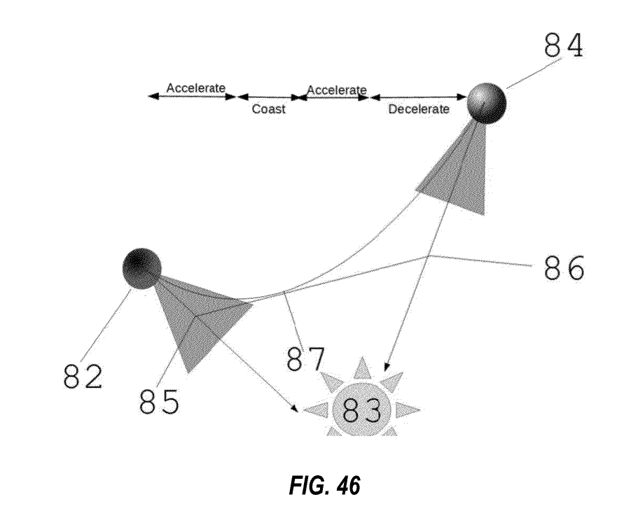

FIG. 46 shows an optimal quadratic course diagram, which shows the same path as in FIG. 45 from the perspective of the Sun's location. There is a cone, bounded on either side of each centerline, where if the craft ventures, it will flip (magnetically), and therefore the coils must be turned off in this region of the path. Fortunately, it also corresponds to when the Reaction Control System of the spacecraft needs to make significant course corrections for the craft to keep it on or near the parabolic course. When back within the angular tolerance of the destination centerline, the craft can resume acceleration or deceleration to minimize the time of the flight.

### EXAMPLE

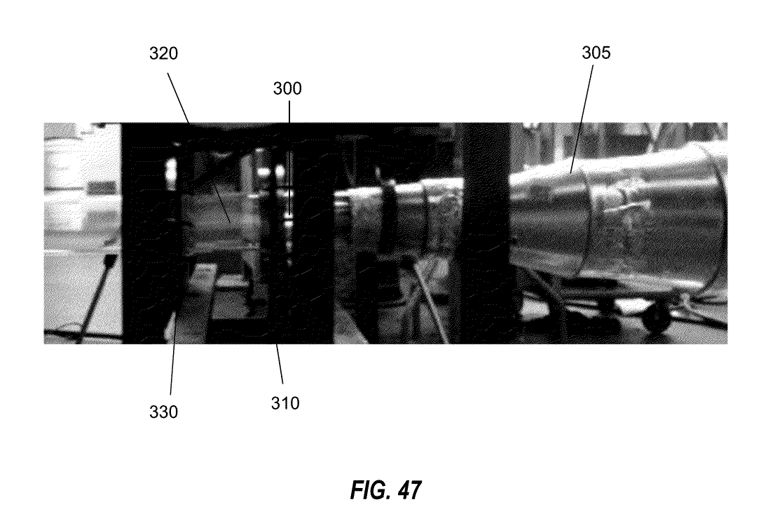

As shown in the photograph of FIG. 47, flame 300 produced by Victor Thermal Dynamics Cutmaster 42 plasma torch 305 running at 30 amps proceeded past two stationary permanent magnets 310, approximately 1.6 T each, surrounding a quartz tube. Ionization 320 occurred between the two magnets 310 and two similar magnets 330 approximately six inches away. The glow signifies the formation of a secondary or Townsend cascade. Because the ionization occurs at UVC wavelengths, a fog generator was used so that it could be seen in the visible spectrum. The blue green color indicates that a mixture of oxygen and nitrogen is being ionized.

Although the invention has been described in detail with particular reference to the disclosed embodiments, other embodiments can achieve the same results. Variations and modifications of the present invention will be obvious to those skilled in the art and it is intended to cover all such modifications and equivalents. The entire disclosures of all patents and publications cited above are hereby incorporated by reference.

What is claimed is:

1. A method of generating thrust using an ionized gas, the method comprising:
ionizing a portion of a first gas;
the ionized first gas ionizing a portion of a second gas in a magnetic field;
the magnetic field creating a Townsend cascade in the first and second ionized gases; and
accelerating the ionized gas to create thrust.

2. The method of claim 1 wherein the magnetic field is produced without requiring external power.

3. The method of claim 1 wherein the magnetic field is produced by permanent magnets, electromagnets or superconductive electromagnetic coils.

4. The method of claim 1 wherein the magnetic field has a strength of greater than approximately one Tesla.

5. The method of claim 1 wherein the magnetic field is solenoid shaped.

6. The method of claim 1 wherein the first gas is ionized by a device selected from the group consisting of plasma torch, electric thruster, ionization pad, laser, solid rocket motor, chemical laser, and trigger diode.

7. The method of claim 1 wherein the second gas is the same as the first gas.

8. The method of claim 1 further comprising increasing a velocity of the first ionized gas using vector addition.

9. The method of claim 8 wherein the vector addition is generated by interactions of ionized gas particles via their gyroradii.

10. The method of claim 8 wherein increasing a velocity of the first ionized gas is performed in a chamber comprising one or more high temperature paramagnetic materials.

11. The method of claim 1 wherein a difference between a velocity of the first gas and a velocity of the second gas exceeds the Critical Ionization Velocity of at least one element in the second gas.

12. The method of claim 11 wherein substantially every molecule of the element is ionized.

13. The method of claim 1 wherein the accelerating step comprises passing the ionized gases pass through one or more coils comprising a logarithmically increasing spacing of adjacent coil segments after the step of creating a Townsend cascade.

14. The method of claim 13 wherein the coils comprise a material selected from the group consisting of permanent magnetic, electromagnetic, or superconductive.

15. The method of claim 13 wherein the coils are arranged in series and/or in parallel.

16. The method of claim 13 comprising subsequently passing the ionized gases through an exhaust nozzle comprising a cone surrounded by a plurality of accelerator coils.

17. The method of claim 16 wherein at least one of the accelerator coils comprises segments which can be selectively energized, thereby enabling control of directionality of an exhaust ion stream.

18. The method of claim 13 comprising subsequently passing the ionized gases through an exhaust nozzle comprising a cone surrounded by a plurality of generator coils which extract energy from the ionized gases.

19. The method of claim 18 comprising subsequently passing the ionized gases through a turbine to generate power.

20. A vehicle for traveling in an electromagnetic field of a celestial body, the vehicle comprising a plurality of parallel superconducting coils circumferentially disposed about an axis of travel of the vehicle, each said coil comprising one or more moveable segments which are reversibly disconnectable from other segments in said coil.

21. The vehicle of claim 20 wherein a polarity of each coil is reversible when one of said moveable segments is disconnected from said coil.

22. The vehicle of claim 20 wherein each said coil comprises an aerogel jacket comprising a superconducting member surrounded by a cryogenic fluid.

23. The vehicle of claim 22 further comprising solenoids to move said moveable segments and seals to prevent leakage of said cryogenic fluid.

24. The vehicle of claim 20 further comprising one or more engines for producing an electromagnetic field for accelerating or decelerating the vehicle.
